(19) United States
(12) Patent Application Publication
(10) Pub. No.: US 2003/0182240 A1
(43) Pub. Date: Sep. 25, 2003

(54) Factoring mediating system

(76) Inventors: Toshihiko Eda, Ibaraki (JP); Takashi Kubokoya, Kanagawa (JP); Tatsuya Setoguchi, Saitama (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/129,951

(22) PCT Filed: Mar. 29, 2001
(86) PCT No.: PCT/JP01/02658

(30) Foreign Application Priority Data
Sep. 14, 2000 (JP) 2000-280209

(51) Int. Cl. G06F 17/60

(52) U.S. Cl. 705/64

(57) ABSTRACT

A factoring commission system [1 of the present invention is characterized by] including a factoring target data generation [means 51] mechanism for receiving charge detail information from a portal site [2] as information regarding a bill and for generating factoring target data to be subjected to factoring based on a condition specified by a supplier from the charge detail information[, and]. A factoring [means 52 for transmitting] mechanism transmits this factoring target data to a purchase financial institution [6] for buying sales credits and for causing the purchase financial institution [6] to extract a purchasable sales credit from the factoring target data and remit a payment for the purchasable sales to a supplier specified financial institution [10]. Thus, it is possible to reduce a burden of data processing for factoring imposed on the supplier, and batch-process factoring requests made to a number of financial institutions.

### TECHNICAL FIELD

The present invention relates to a factoring commission system for selling on commission sales credits generated by sales transactions on a portal site or the like by using a computer system and, more particularly, to a factoring commission system capable of reducing a data processing burden imposed on a supplier, and batch-processing factoring requests made to a number of financial institutions.

### BACKGROUND ART

In business transactions between companies, when business negotiation is successfully conducted, and delivery of goods is completed, an account receivable is generated for the supplier. Conventionally, each company has carried out factoring designed to obtain funds by selling this account receivable as a sales credit to a bank.

Conventionally, however, a supplier requesting factoring has had to prepare data necessary for factoring by adjusting accounts receivable for each buyer and each due date of payment himself. Thus, a requirement of the supplier to carry out complex data processing has been a problem.

In addition, conventionally, it has been limited to a particular financial institution such as a bank of account that the supplier makes a factoring request. Thus, impossibility of factoring among a number of financial institutions has been a problem.

The present invention has been made with the above-described problems in mind, and it is an object of the invention to provide a factoring commission system capable of reducing a burden of data processing for factoring imposed on a supplier, and batch-processing factoring requests made to a number of financial institutions.

### DISCLOSURE OF THE INVENTION

In order to achieve the foregoing object, a factoring commission method of the present invention described in claim 1 is provided to carry out transactions between a supplier for supplying goods and a buyer for buying the goods through a portal site by a computer system, and sell on commission sales credits generated by the transactions by using a server. This factoring commission method is characterized in that the server generates factoring target data to be subjected to factoring from charge detail information as information regarding a bill of charges generated as a result of the transactions on the portal site based on a factoring condition specified by the supplier, transmits the factoring target data to a purchase financial institution for buying sales credits, and causes the purchase financial institution to extract a purchasable sales credit from the factoring target data and remit a payment for the purchasable sales credit to a supplier specified financial institution specified by the supplier.

According to the invention of claim 1, it is possible to reduce a burden of data processing for factoring imposed on the supplier and batch-process factoring requests made to a number of financial institutions.

A factoring commission apparatus of the present invention described in claim 2 is provided to sell on commission sales credits generated by transactions, which are carried out between a supplier for supplying goods and a buyer for buying the goods through a portal site by a computer system. The factoring commission apparatus is characterized by including: factoring target data generation means for receiving charge detail information from the portal site as information regarding a bill of charges generated as a result of the transactions on the portal site and for generating factoring target data to be subjected to factoring based on a factoring condition specified by the supplier from the charge detail information; and factoring means for transmitting the factoring target data generated by the factoring target data generation means to a purchase financial institution for buying sales credits, and causing the purchase financial institution to extract a purchasable sales from the factoring target data and send a payment for the purchasable sales credit to a supplier specified financial institution specified by the supplier.

According to the invention of claim 2, it is possible to reduce a burden of data processing for factoring imposed on the supplier and batch-process factoring requests made to a number of financial institutions.

The factoring target data generation means of the factoring commission apparatus of the invention described in claim 3 is characterized by searching the charge detail information based on a search condition entered by the supplier, and providing the charge detail information coincident with the search condition to the supplier.

According to the invention of claim 3, since the charge detail information coincident with the search condition is supplied to the supplier, the supplier can easily select a sales credit desired to be subjected to factoring.

The factoring commission apparatus of the invention described in claim 4 is characterized by further including distribution certifying means for presenting to the purchase financial institution a distribution certificate certifying that transacted goods have been delivered by a distribution company.

According to the invention of claim 4, since the purchase financial institution can extract a credit available for factoring by referring to the distribution certificate, the purchase financial institution can buy sales credits without anxiety.

The factoring means of the factoring commission apparatus of the invention described in claim 5 is characterized in that a purchase condition of the purchasable sales credit, which is extracted by the purchase financial institution, is adjusted and decided between the supplier and the purchase financial institution.

According to the invention of claim 5, since the purchase condition can be adjusted between the supplier and the purchase financial institution, sales credits can be sold and bought therebetween on a best condition.

The factoring commission apparatus of the invention described in claim 6 is characterized by further including credit investigation information providing means for providing credit investigation information regarding a credit of a company.

According to the invention of claim 6, since the purchase financial institution can extract a credit available for factoring by referring to the credit investigation information, the purchase financial institution can buy sales credits without anxiety.

The factoring commission apparatus of the invention described in claim 7 is characterized by further including factoring state providing means for providing information regarding a sales credit coincident with a factoring state search condition when the factoring state search condition for searing a factoring sate is entered.

According to the invention of claim 7, a factoring commission company can always understand a factoring commission state and verify credits that cannot be collected because of bankruptcy or the like.

A factoring commission program of the invention described in claim 8 is provided to sell on commission sales credits generated by transactions, which are carried out between a supplier for supplying goods and a buyer for buying the goods through a portal site by a computer system. This factoring commission program is characterized by including: factoring target data generation for receiving charge detail information from the portal site as information regarding a bill of charges generated as a result of the transactions on the portal site and for generating factoring target data to be subjected to factoring based on a factoring condition specified by the supplier from the charge detail information; and factoring for transmitting the factoring target data generated in the factoring target data generation to a purchase financial institution for buying sales credits and for causing the purchase financial institution to extract a purchasable sales credit from the factoring target data and remit a payment for the purchasable sales credit to a supplier specified financial institution specified by the supplier.

According to the invention of claim 8, it is possible to reduce a burden of data processing for factoring imposed on the supplier and batch-process factoring requests made to a number of financial institutions.

The factoring target data generation process of the factoring commission program of the invention described in claim 9 is characterized by searching the charge detail information based on a search condition entered by the supplier and providing the charge detail information coincident with the search condition to the supplier.

According to the invention of claim 9, since the charge detail information coincident with the search condition is provided to the supplier, the supplier can easily select a sales credit desired to be subjected to factoring.

The factoring commission program of the invention described in claim 10 is characterized by further including distribution certifying process for presenting to the purchase financial institution a distribution certificate certifying that transacted goods have been delivered by a distribution company.

According to the invention of claim 10, since the purchase financial institution can extract a credit available for factoring by referring to the distribution certificate, the purchase financial institution can buy sales credits without anxiety.

The factoring process of the factoring commission program of the invention described in claim 11 is characterized in that a purchase condition of the purchasable sales credit extracted by the purchase financial institution is adjusted and decided between the supplier and the purchase financial institution.

According to the invention of claim 11, since the purchase condition can be adjusted between the supplier and the purchase financial institution, sales credits can be sold and bought therebetween on a best condition.

The factoring commission program of the invention described in claim 12 is characterized by further including credit investigation information providing process for providing credit investigation information regarding credit of a company.

According to the invention of claim 12, since the purchase financial institution can extract a credit available for factoring by referring to the credit investigation information, the purchase financial institution can buy sales credits without anxiety.

The factoring commission program of the invention described in claim 13 is characterized by further including factoring state providing process for providing information regarding a sales credit coincident with a factoring state search condition when the factoring state search condition for searching a factoring sate is entered.

According to the invention of claim 13, a factoring commission company can always understand a factoring commission state, and verify credits that cannot be collected because of bankruptcy or the like.

A supplier terminal of the present invention described in claim 14 is provided for a supplier to supply goods information to a portal site by a computer system, and sell goods by transactions with a buyer. The supplier terminal is characterized by prompting the supplier to specify a factoring condition for generating factoring target data to be subjected to factoring from charge detail information as information regarding a bill of charges generated as a result of the transactions on the portal site, transmitting the factoring condition to a server when the factoring condition is specified by the supplier, factoring target data is generated by the server, and receiving a notice of receipt of money for verifying a payment after a purchase financial institution extracts a purchasable sales credit from the factoring target data, and the payment for the purchasable sales credit is received by a supplier specified financial institution specified by the supplier.

According to the invention of claim 14, it is possible to reduce a burden of data processing for factoring imposed on the supplier and batch-process factoring requests made to a number of financial institutions.

The supplier terminal of the invention described in claim 15 is characterized in that when a search condition for searching possessed sales credits is entered by the supplier, the search condition is transmitted to the server, and charge detail information searched based on the search condition is received from the server and provided to the supplier.

According to the invention of claim 15, since the charge detail information coincident with the search condition is provided to the supplier, the supplier can easily select a sales credit desired to be subjected to factoring.

The supplier terminal of the invention described in claim 16 is characterized by prompting said supplier to enter a response to said purchase condition when a purchase condition of said purchasable sales credit, which is entered by said purchase financial institution, is received from said server, and transmitting said response to said server when said response is entered.

According to the invention of claim 16, since the supplier can negotiate the purchase condition with the purchase financial institution, the supplier can sell sales credits on a best condition.

### BRIEF DESCRIPTION OF THE DRAWINGS

FIG. 1 is a block diagram showing a configuration of a factoring commission system according to a first embodiment of the present invention.

FIG. 2 is a flowchart illustrating member information registration in the factoring commission system shown in FIG. 1.

FIG. 3 is a view showing an example of a registration screen of a financial institution in the member information registration shown in FIG. 2.

FIG. 4 is a view showing an example of a display screen of member information in the member information registration shown in FIG. 2.

FIG. 5 is a flowchart illustrating a sales transaction of goods on a portal site shown in FIG. 1.

FIG. 6 is a flowchart illustrating factoring on commission in the factoring commission system shown in FIG. 1.

FIG. 7 is a view showing an example of a total table of sales credits possessed by a supplier in the factoring on commission shown in FIG. 6.

FIG. 8 is a view showing a detail of the total table of the possessed sales credits shown in FIG. 7.

FIG. 9 is a view showing an example of an entry screen of factoring conditions in the factoring on commission shown in FIG. 6.

FIG. 10 is a view showing an example of a list screen of factoring target data in the factoring on commission shown in FIG. 6.

FIG. 11 is a view showing a detail of the factoring target data shown in FIG. 10.

FIG. 12 is a view showing an example of a list screen of credits, which can be subjected to factoring in the factoring on commission shown in FIG. 6.

FIG. 13 is a view showing a detail of the credits available for factoring shown in FIG. 12.

FIG. 14 is a view showing an example of a factoring execution request screen in the factoring on commission shown in FIG. 6.

FIG. 15 is a view showing an example of a report screen of purchased credits in the factoring on commission shown in FIG. 6.

FIG. 16 is a view showing an example of a list screen of uncollected credits in the factoring on commission shown in FIG. 6.

FIG. 17 is a block diagram showing a configuration of a factoring commission system according to a second embodiment of the present invention.

FIG. 18 is a flowchart illustrating a sales transaction of goods on a portal site shown in FIG. 17.

FIGS. 19A and 19B are flowcharts illustrating factoring on commission in the factoring commission system shown in FIG. 17.

FIG. 20 is a view showing a factoring application screen in the factoring on commission shown in FIGS. 19A and 19B.

FIG. 21 is a view showing an example of a total table of possessed sales credits in the factoring on commission shown in FIGS. 19A and 19B.

FIG. 22 is a view showing a detail of the total table of the possessed sales credits shown in FIG. 21.

FIG. 23 is a view showing the detail table of the possessed sales credits in detail shown in FIG. 22.

FIG. 24 is a view showing a detailed content of the possessed sales credits shown in FIG. 23.

FIG. 25 is a view showing an example of a search condition entry screen in searching of factoring targets in the factoring on commission shown in FIGS. 19A and 19B.

FIG. 26 is a view showing an example of a searched result in the searching of the factoring targets in the factoring on commission shown in FIGS. 19A and 19B.

FIG. 27 is a view showing an example of an entry screen of factoring conditions in the factoring on commission shown in FIGS. 19A and 19B.

FIG. 28 is a view showing an example of an entry screen of factoring conditions in the factoring on commission shown in FIGS. 19A and 19B.

FIG. 29 is a view showing an example of a list screen of factoring target data in the factoring on commission shown in FIGS. 19A and 19B.

FIG. 30 is a view showing a detail of the factoring target data shown in FIG. 29.

FIG. 31 is a view showing an example of a list screen of purchasable credits in the factoring on commission shown in FIGS. 19A and 19B.

FIG. 32 is a view showing a detail of the purchasable credits shown in FIG. 31.

FIG. 33 is a view showing in detail a detail table of the purchasable credits shown in FIG. 32.

FIG. 34 is a view showing a detailed content of the purchasable credits shown in FIG. 33.

FIG. 35 is a view showing an example of a selection screen of credit investigation information in the factoring on commission shown in FIGS. 19A and 19B.

FIG. 36 is a view showing an example of credit investigation information in the factoring on commission shown in FIGS. 19A and 19B.

FIG. 37 is a view showing an example of a distribution certificate presented in the factoring on commission shown in FIGS. 19A and 19B.

FIG. 38 is a view showing an example of an entry screen of purchase conditions in the factoring on commission shown in FIGS. 19A and 19B.

FIG. 39 is a view showing an example of an adjustment screen of purchase conditions in the factoring on commission shown in FIGS. 19A and 19B.

FIG. 40 is a view showing an example of an input screen of purchase conditions in the factoring handing shown in FIGS. 19A and 19B.

FIG. 41 is a view showing an example of an adjustment screen of purchase conditions in the factoring on commission shown in FIGS. 19A and 19B.

FIG. 42 is a view showing an example of a comment recording screen in the factoring on commission shown in FIGS. 19A and 19B.

FIG. 43 is a view showing an example of a list screen of credits available for factoring, in the factoring on commission shown in FIGS. 19A and 19B.

FIG. 44 is a view showing a detail of the credits available for factoring shown in FIG. 43.

FIG. 45 is a view showing an example of a factoring execution request screen in the factoring on commission shown in FIGS. 19A and 19B.

FIG. 46 is a view showing an example of a report screen of purchased credits in the factoring on commission shown in FIGS. 19A and 19B.

FIG. 47 is a view showing an example of a list screen of uncollected credits in the factoring on commission shown in FIGS. 19A and 19B.

FIG. 48 is a view showing an example of a search screen of a factoring state in the factoring on commission shown in FIGS. 19A and 19B.

FIG. 49 is a view showing an example of a list screen of uncollected credits in the factoring on commission shown in FIGS. 19A and 19B.

### BEST MODES FOR CARRYING-OUT THE INVENTION

Next, description will be made for a factoring commission system according to an embodiment of the present invention with reference to the accompanying drawings.

(First Embodiment)

1. System Configuration

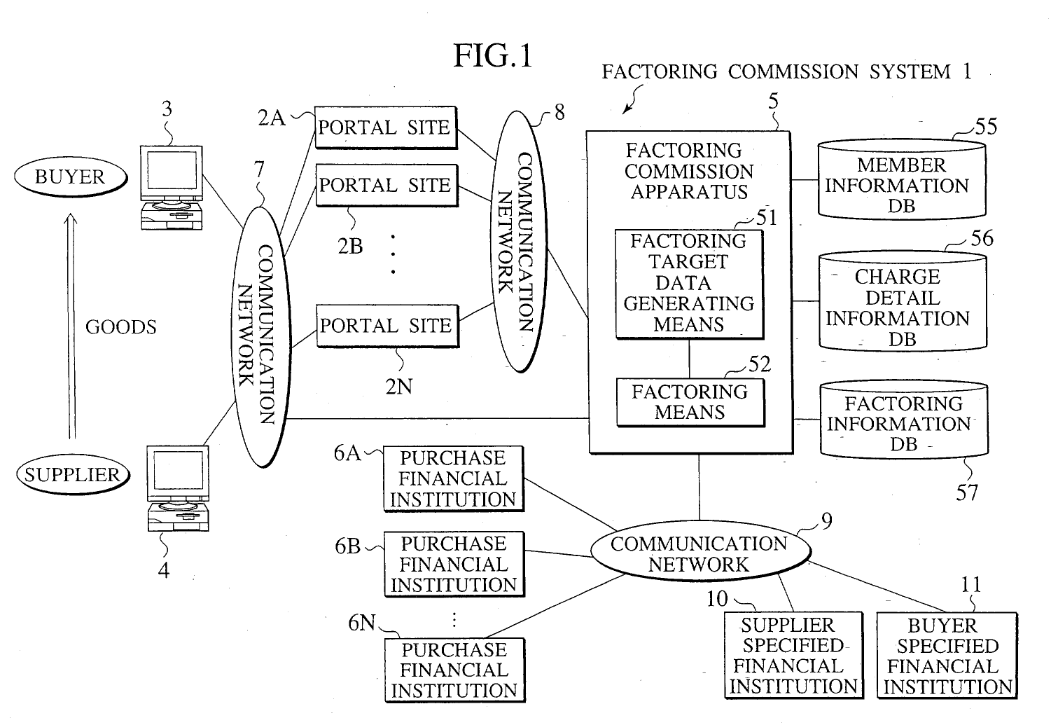

As shown in FIG. 1, a factoring commission system 1 of the present embodiment includes: a buyer terminal 3 of a buyer company for buying goods by accessing portal sites 2A, 2B, . . . , and 2N; a supplier terminal 4 of a supplier company for supplying goods information to the portal sites 2A, 2B, . . . , and 2N; a factoring commission apparatus 5 functioning as a server to execute factoring on commission based on sales credits generated by transactions between the supplier and the buyer; purchase financial institutions 6A, 6B, . . . , and 6N for buying the sales credits generated by the sales transactions; a supplier specified financial institution 10 specified by the supplier as a receiver of money paid for the sales credits; and a buyer specified financial institution 11 specified by the buyer as a receiver of accounts receivable.

In this case, the buyer terminal 3, the supplier terminal 4, the portal sites 2A, 2B, . . . , and 2N, and the factoring commission apparatus 5 are interconnected by the communication network 7. The portal sites 2A, 2B, . . . , and 2N, and the factoring commission apparatus 5 are interconnected by a communication network 8. The factoring commission apparatus 5 and the financial institutions 6A, . . . , 6N, 10 and 11 are interconnected by a communication network 9. The communication networks 7, 8 and 9 are composed of communication lines such as the Internet, dial-up, a dedicated line, VPN, and a radio connection. Especially, connection is made in the communication network 8 based on protocol of TCP/IP or SAP R3, and connection is made in the communication network 9 based on Zengin protocol (Standard Communication Protocol of Japanese Bankers Association), or a SWIFT format in overseas remittance.

Further, the factoring commission apparatus 5 includes factoring target data generation means 51 for receiving charge detail information as information regarding a bill of charges generated by transactions on the portal sites 2A, 2B, . . . , and 2N, and generating factoring target data to be subjected to factoring from the charge detail information based on a condition specified by the supplier, and factoring means 52 for transmitting the factoring target data generated by the factoring target data generation means 51 to a purchase financial institution 6, and causing the purchase financial institution 6 to extract a purchasable sales credit from the factoring target data and remit a payment for the purchasable sales credit to the supplier specified financial institution 10.

The factoring commission apparatus 5 is a server composed of a general computer system including a CPU for executing various processing operations and a storing means for storing commands of the operations, managed by a so-called Internet provider, and connected through the Internet to a not-shown host computer. When access is made from the buyer terminal 3 or the supplier terminal 4 through the communication network 7 or 8, the factoring commission apparatus 5 provides a home page directed to the buyer or the supplier. On this home page, information regarding an inquiry of the factoring target data or a result of factoring is displayed.

In addition, the factoring commission apparatus 5 includes: a member information database 55 for storing member information of a buyer or a supplier as a member of the factoring commission system 1; a charge detail information database 56 for storing charge detail information as information regarding a bill of charges generated by transactions on the portal sites 2A, 2B, . . . , and 2N; and a factoring information database 57 for storing information necessary for factoring such as the factoring target data.

Here, the member information database 55 stores information such as a company name, an office name, a name of division in charge, a zip code, an address, a name of a person in charge, a telephone number, a FAX number, a specified financial institution name, a type of business, a portal ID, a portal member ID, a contract ID and a user ID for individual buyers and suppliers as member information thereof.

The charge detail information database 56 stores information such as a control ID, a charge number, a buyer's name, a contract ID and a user ID of a buyer, a supplier's name, a contract ID and a user ID of a supplier, a name of goods, the number of goods, a volume of goods, a unit price, a name of a financial institution and a due date of payment for individual bills of charges as charge detail information.

Each of the financial institutions 6A, 6B, . . . , 6N, 10 and 11 includes a bank, a finance company or the like. The purchase financial institution 6 extracts a purchasable sales credit from the factoring target data, remits a payment for the purchasable sales credit for the supplier specified financial institution 10, and executes credit protection such as inhibition of payment from a receiving account to the buyer specified financial institution 11 as a receiver of accounts receivable.

2. Operation

Next, description will be made for each processing carried out by the factoring commission system 1 of the present embodiment with reference to the accompanying drawings.

2-1. Member Information Registration

First, description will be made for member information registration of a buyer and a supplier by the factoring commission system 1 of the embodiment.

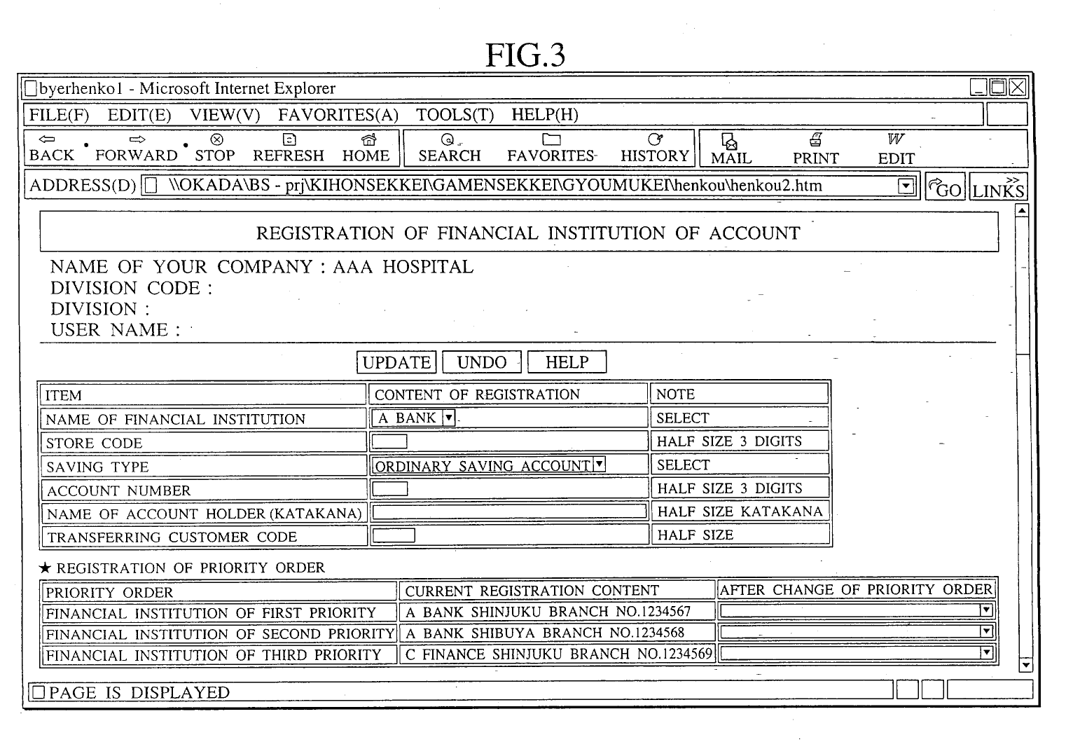

A buyer trying to use factoring on commission by the factoring commission system 1 of the embodiment applies for membership by accessing the portal site 2 for transactions from the buyer terminal 3 (S201). In this case, the buyer enters member information such as a company name, an office name, and a name of a specified financial institution. Especially, the entry of the specified financial institution is executed on an entry screen similar to that shown in FIG. 3. A plurality of buyer specified financial institutions for payments of accounts receivable can be specified, and priorities thereof can be specified.

After the entry of member information, the portal site 2 provides a portal member ID, and carries out buyer member registration (S202).

Similarly, a supplier applies for membership by accessing the portal site 2 from the supplier terminal 4 (S203), and enters member information such as a company name, an office name and a supplier specified financial institution as a receiver of money for sales credits. Based on such member information, the portal site 2 provides a portal member ID, and carries out supplier member registration (S204).

After the member registration, the portal site 2 adds a portal ID for specifying a portal site to the member information, and transmits the member information to the factoring commission apparatus 5 (S205).

Then, upon having received the member information, the portal ID and the portal member ID, the factoring commission apparatus 5 provides a contract ID and a user ID as a member ID of the factoring commission apparatus 5 and resisters the member information (S206), and then stores the member information in the database 55.

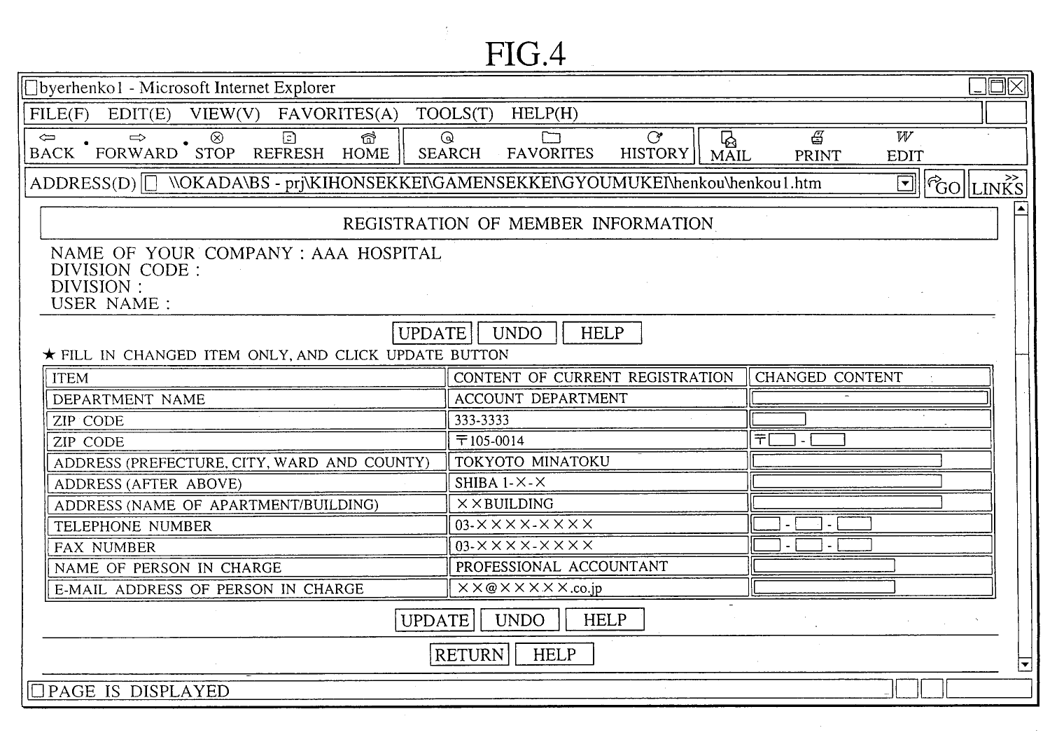

After the member information has been registered, a registration verification screen similar to that shown in FIG. 4 is presented to each of the supplier 4, the buyer 3 and the portal site 2, and the member information is verified (S207), thus completing the registration.

The specified financial institution and the member information can be changed from the screens of FIGS. 3 and 4, respectively.

2-2. Sales Transaction of Goods on Portal Site

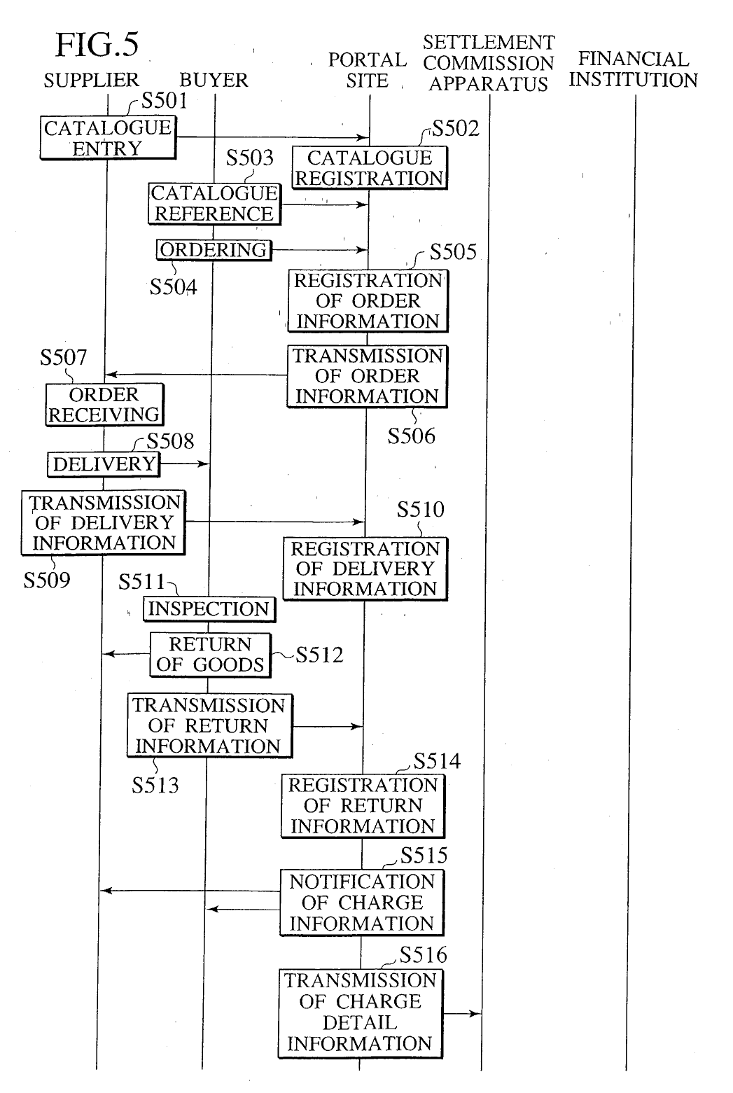

Next, description will be made for sales transactions of goods on the portal site 2 based on a flowchart of FIG. 5.

First, the supplier accesses the portal site 2 from the supplier terminal 4, and writes goods to be sold in a catalogue of the portal site 2 (S501). Upon reception thereof, the portal site 2 registers the goods in the catalogue (S502).

Then, the buyer accesses the portal site 2 from the buyer terminal 3 and refers to the catalogue (S503). When there are goods that the buyer wants to buy, the buyer sends an order to the portal site 2 (S504). Upon reception of the order, the portal site 2 receives and resisters order information thereof (S505).

Then, the order information is transmitted to the supplier terminal 4 of the supplier (S506). The supplier receives the order based on the order information (S507), delivers the ordered goods to the buyer (S508), and transmits delivery information to the portal site 2 (S509). Then, the portal site 2 resisters the delivery information (S510).

The buyer having received the goods inspects the delivered goods (S511), returns the goods to the supplier if they are defective (S512), and transmits return information to the portal site 2 (S513). Then, the portal site 2 registers the return information (S514).

After the registration of the delivery information and the return information at the portal site 2, the portal site 2 generates charge information based on the delivery information and the return information, and notifies the generated charge information to both of the supplier and the buyer (S515). Then, the portal site 2 extracts information necessary for settlement from the charge information to generate charge detail information, and transmits the generated charge detail information to the factoring commission apparatus 5 (S516), thus completing the sales transaction of the goods on the portal site 2.

If the charge detail information contains an error or unnecessary information, then the portal site 2 transmits the charge detail information having a control ID added to indicate a status, such as a change or deletion to the factoring commission apparatus 5. The factoring commission apparatus 5 specifies a bill based on a bill number, and executes updating, deleting or the like in accordance with the status of the control ID.

2-3. Factoring on Commission

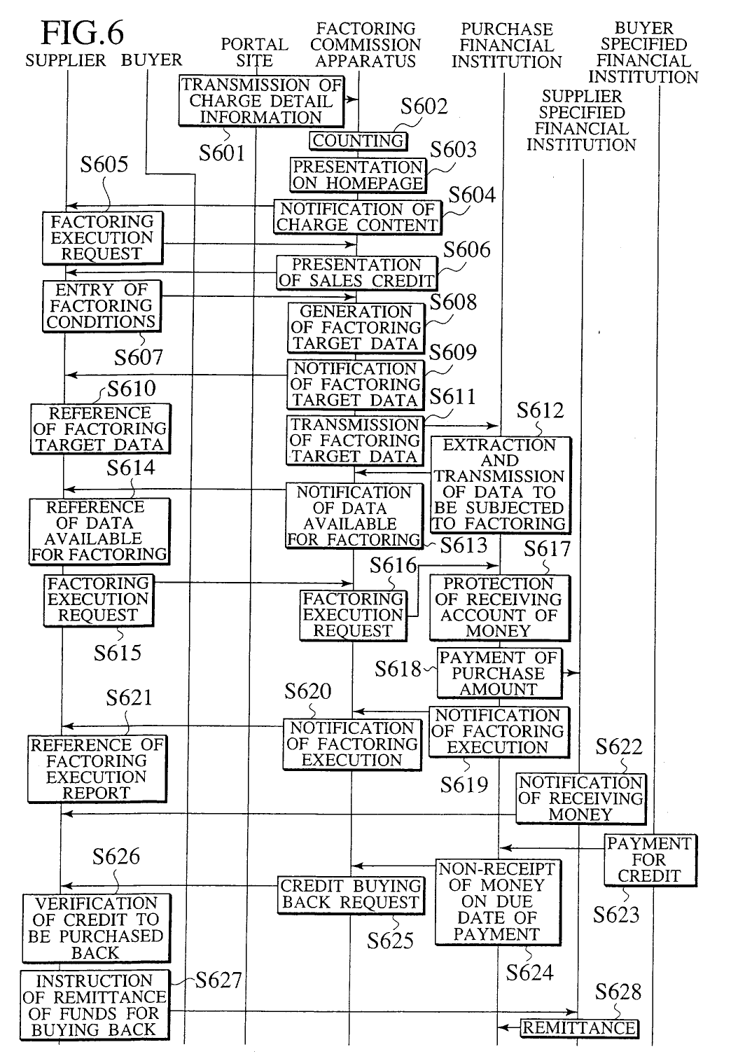

Next, description will be made for factoring on commission by the factoring commission apparatus 5 of the embodiment based on a flowchart of FIG. 6.

As shown in FIG. 6, when charge detail information is transmitted from the contracted portal site 2A, 2B, . . . , or 2N (S601), the factoring commission apparatus 5 receives the charge detail information, and stores the same in the charge detail information database 56.

Then, the factoring commission apparatus 5 periodically reads the charge detail information stored in the charge detail information database 56, executes monthly or weakly counting for individual suppliers (S602), presents a content of a bill for each supplier based on the counting on the home page for the suppliers (S603), and notifies the content of the bill to the supplier by electronic mail or the like (S604).

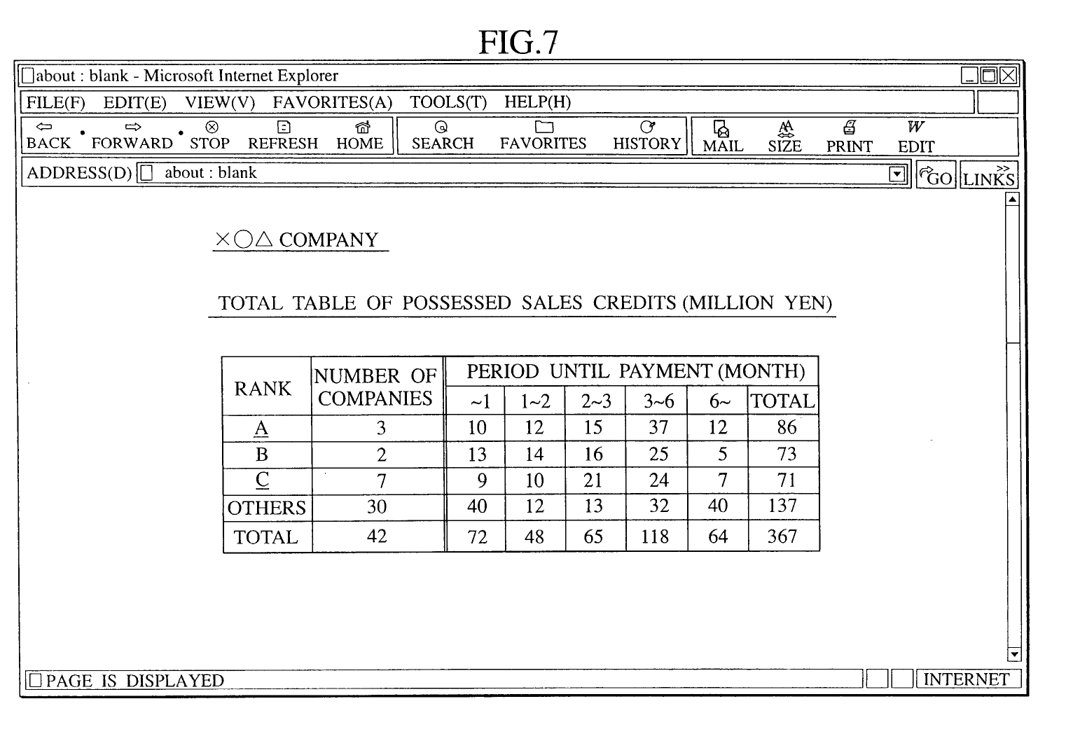

Upon having been notified of the bill, the supplier transmits an execution request of factoring to the factoring commission apparatus 5. Accordingly, the factoring commission apparatus 5 searches the charge detail information database 56, and extracts a sales credit possessed by the supplier to show a total table of sales credits similar to that shown in FIG. 7 (S606). Then, information regarding the extracted sales credit is stored in the factoring information database 57.

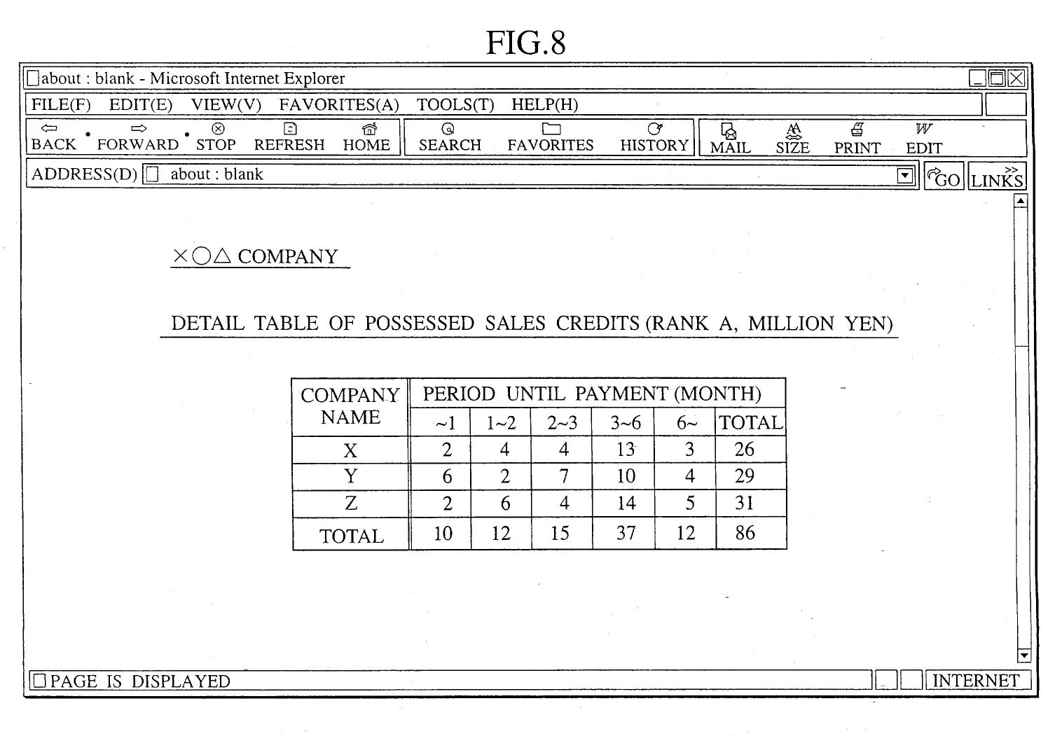

In this case, the total table of sales credits in FIG. 7 shows a classification of sales credits possessed by xOΔ Company based on a period until payment and a rank indicating a credit rating of a buyer company, and each total amount of sales credits is shown. By clicking a rank A on the screen of FIG. 7, a detail table of sales credits similar to that shown in FIG. 8 is displayed, showing sales credits of buyers of rank A for each company.

In addition, the supplier can add bills generated by transactions other than those on the portal site to the table of FIG. 7.

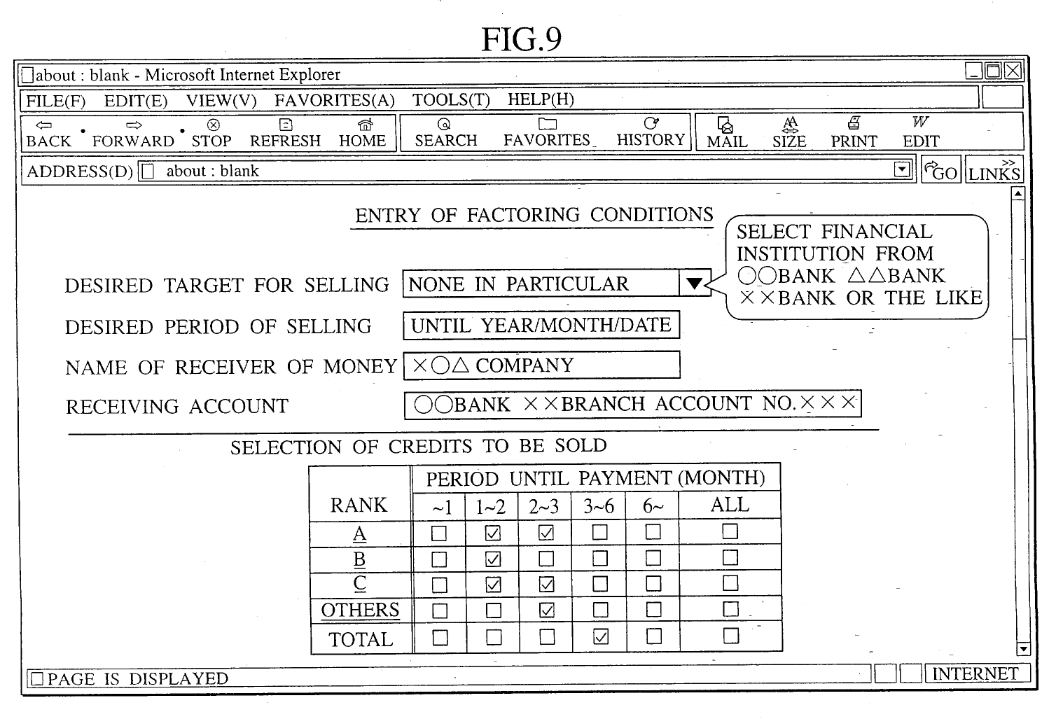

After the presentation of the information regarding sales credits on the screen similar to that of FIG. 7 or 8, the supplier enters a factoring condition on an entry screen of factoring conditions shown in FIG. 9 by referring to the information (S607).

On the condition entry screen of FIG. 9, a credit desired to be sold is selected based on a rank and a period until payment, and a purchase financial institution as a desired buyer of the credit, a desired term of selling, a name of a receiver of money, and a receiving account are entered. In this case, if no particular purchase financial institutions are specified, a purchase financial institution is selected and specified by the factoring commission apparatus 5.

As described above, since the supplier can specify a factoring condition, factoring can be carried out as desired by the supplier. Especially, since the purchase financial institution can be specified among a number of financial institutions, the supplier can make factoring requests to many financial institutions.

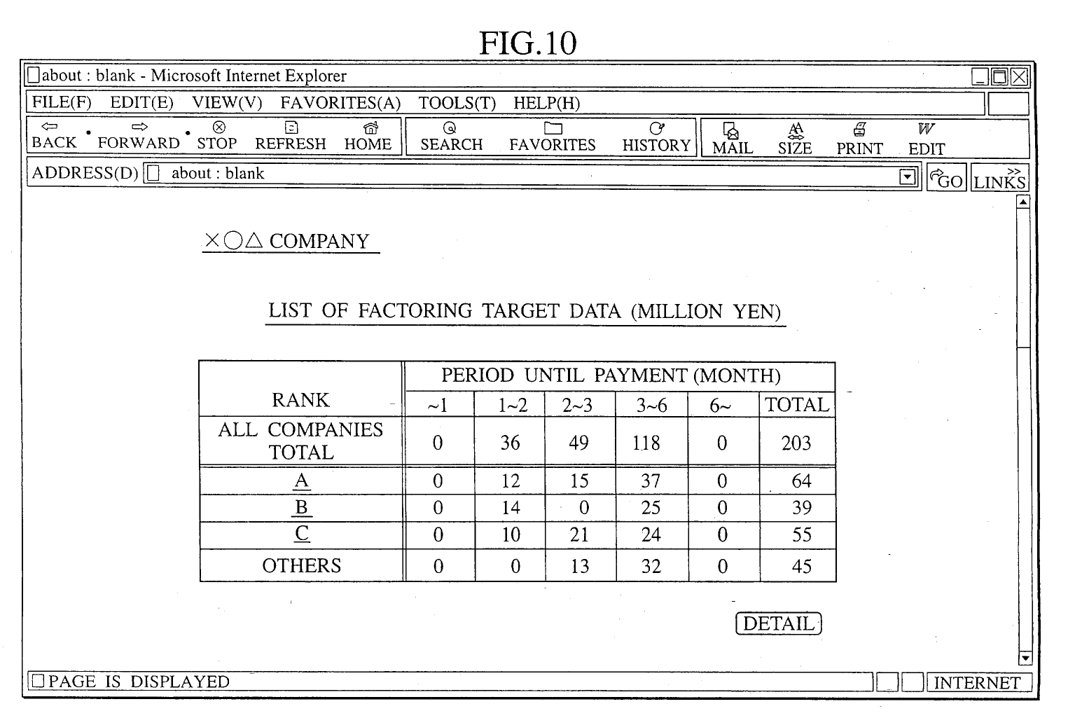

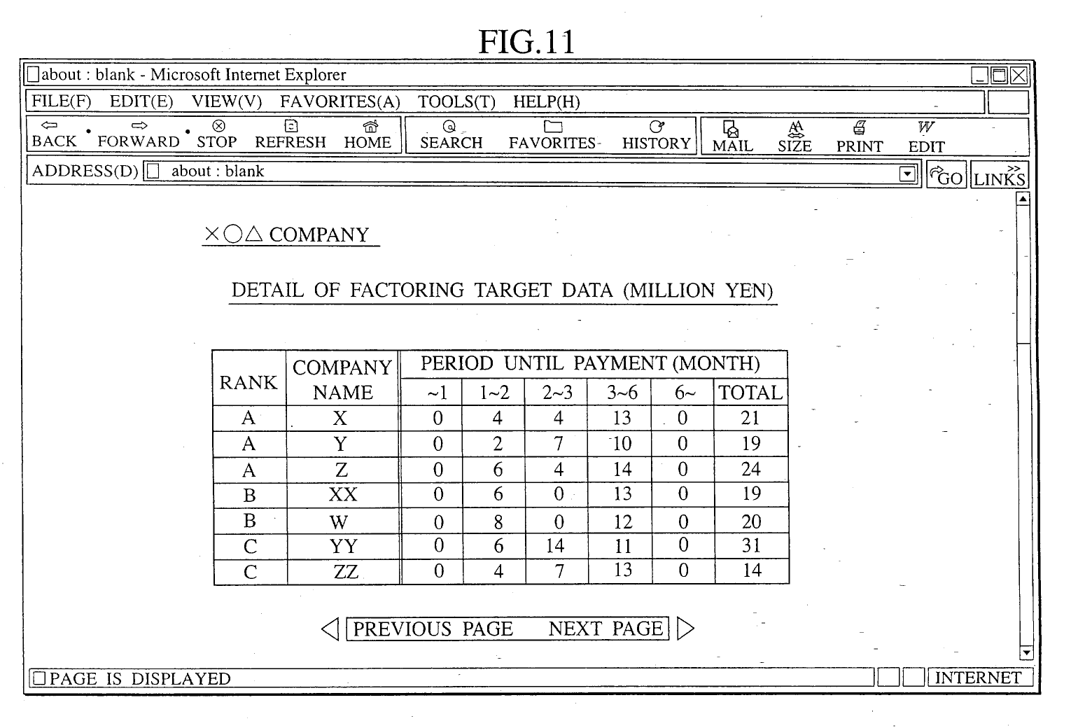

After the factoring condition has been specified in the above-described manner, the factoring commission apparatus 5 selects and generates factoring target data to be subjected to factoring from sales credits possessed by the supplier based on the factoring condition (S608). Then, the generated factoring target data is notified to the supplier (S609), and the supplier having received the notice refers to the factoring target data on a list screen of factoring target data shown in FIG. 10 (S610). In this case, by clicking a “DETAIL” button on the list screen of FIG. 10, a detail of factoring target data for each company shown in FIG. 11 can be referred to.

On the other hand, the generated factoring target data is also transmitted to the purchase financial institution 6 for executing factoring (S611).

Upon having received the factoring target data, the purchase financial institution 6 considers a credit rating of the buyer, a risk and the like, extracts data which can be subjected to factoring from the factoring target data requested by the supplier, and transmits the data to the factoring commission apparatus 5 (S612).

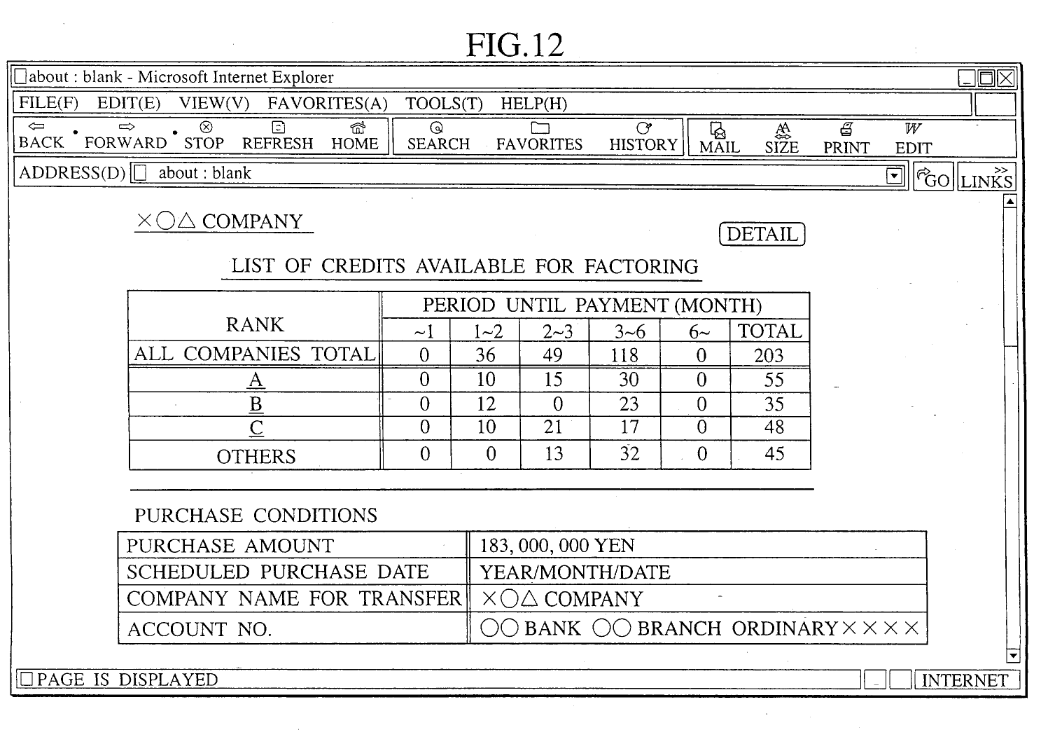

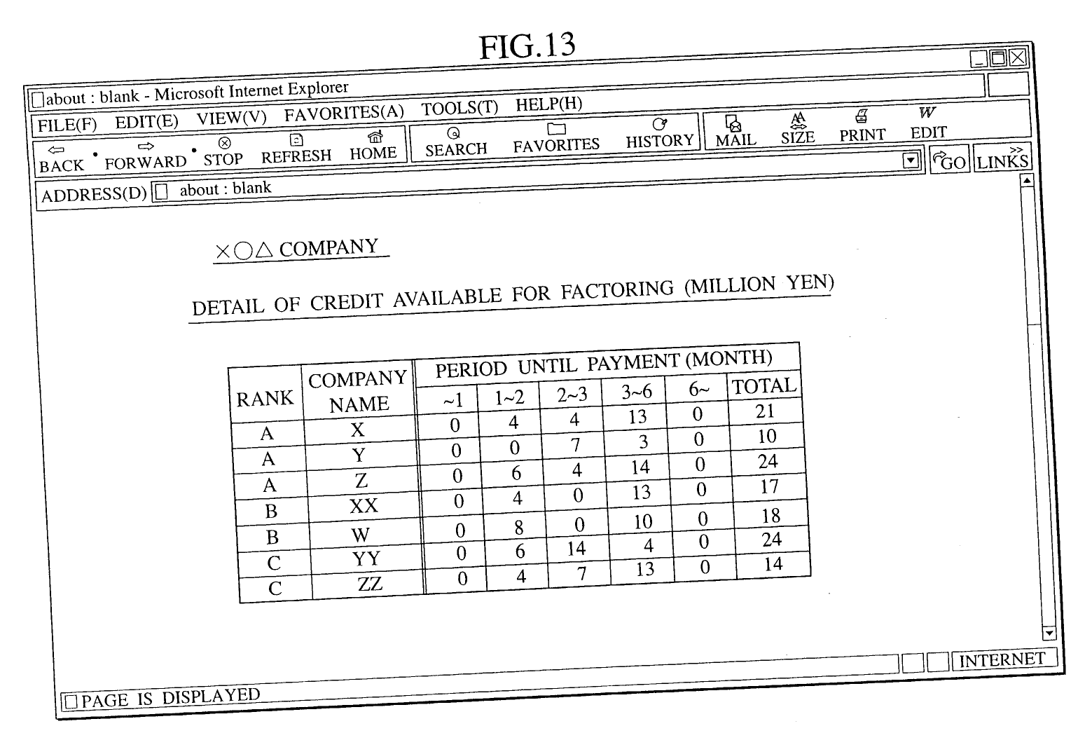

Upon having received the data available for factoring, the factoring commission apparatus 5 stores the data in the factoring information database 57, and notifies the data available for factoring to the supplier (S613). The supplier can refer to the data available for factoring on a list screen of credits available for factoring shown in FIG. 12 (S614). On the list screen, the credits available for factoring are shown by being classified by a rank and a period until payment. FIG. 12 shows that the purchase financial institution 6 has agreed to buy displayed credits by 183 million yen as a total amount of the credits. On the list screen of FIG. 12, by clicking a “DETAIL” button, a detail of credits available for factoring can be referred to for each company shown in FIG. 13.

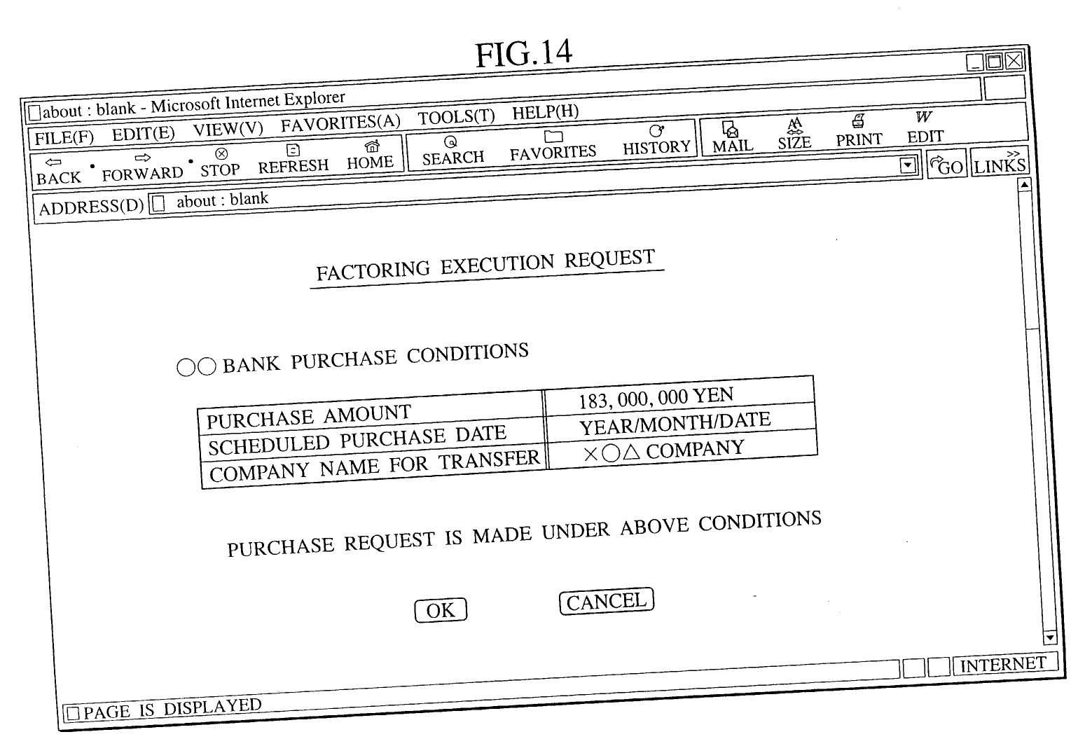

Then, by referring to FIGS. 12 and 13, when the supplier makes a factoring execution request to the purchase financial institution 6, a factoring execution request is entered on a request screen of FIG. 14, and transmitted to the factoring commission apparatus 5 (S615).

The factoring commission apparatus 5 transmits the received execution request to the purchase financial institution 6 (S616). A receiving account of purchased credits is protected at the purchase financial institution 6 (S617), a purchase amount of money is received by the supplier specified financial institution 10 specified by the supplier (S618), and a factoring execution notice is returned to the factoring commission apparatus 5 (S619).

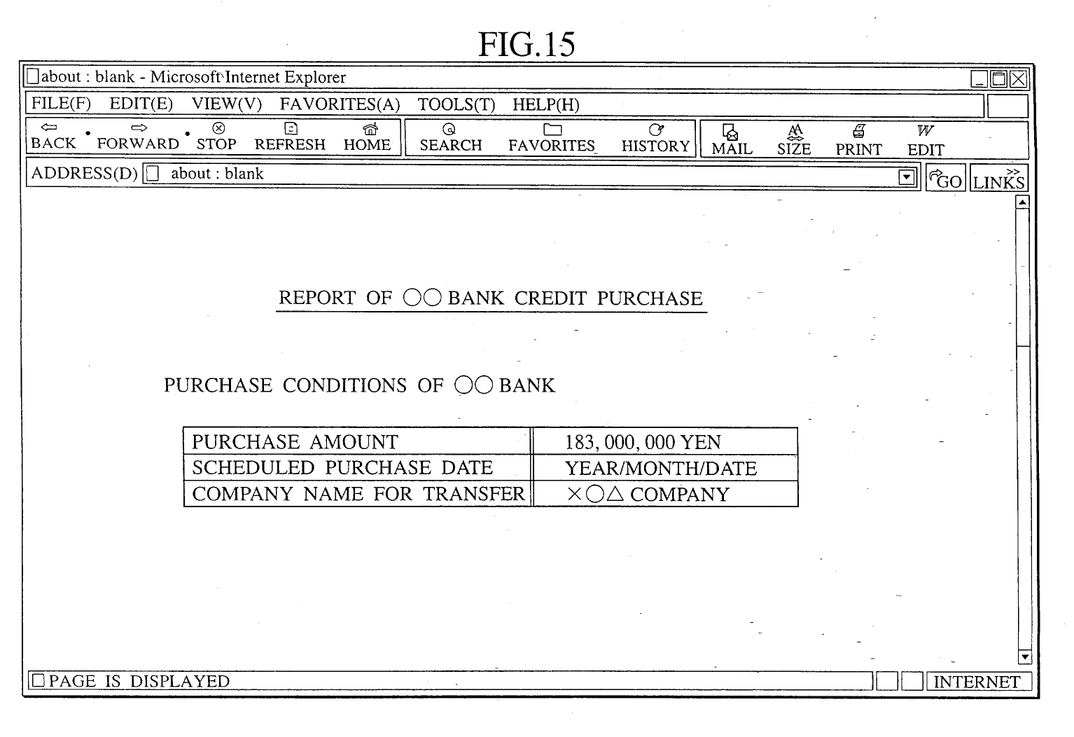

The factoring execution notice is transmitted from the factoring commission apparatus 5 to the supplier (S620). The supplier refers to a credit purchase report made by the purchase financial institution 6 on a report screen shown in FIG. 15 (S621).

Further, after the purchase amount of money has been received by the account of the supplier, the supplier specified financial institution 10 transmits a notice of a receipt of money to the supplier (S622).

Subsequently, the buyer specified financial institution 11 pays for the credits to the purchase financial institution 6 not later than a due date of payment (S623). In this case, if the factored credits are not paid for not later than the due date of payment, then the supplier buys back the credits that have been sold.

First, if any of the factored credits are not paid for on a due date of payment because of bankruptcy of the buyer or the like, the purchase financial institution 6 transmits a notice of non-receipt of money to the factoring commission apparatus 5 (S624).

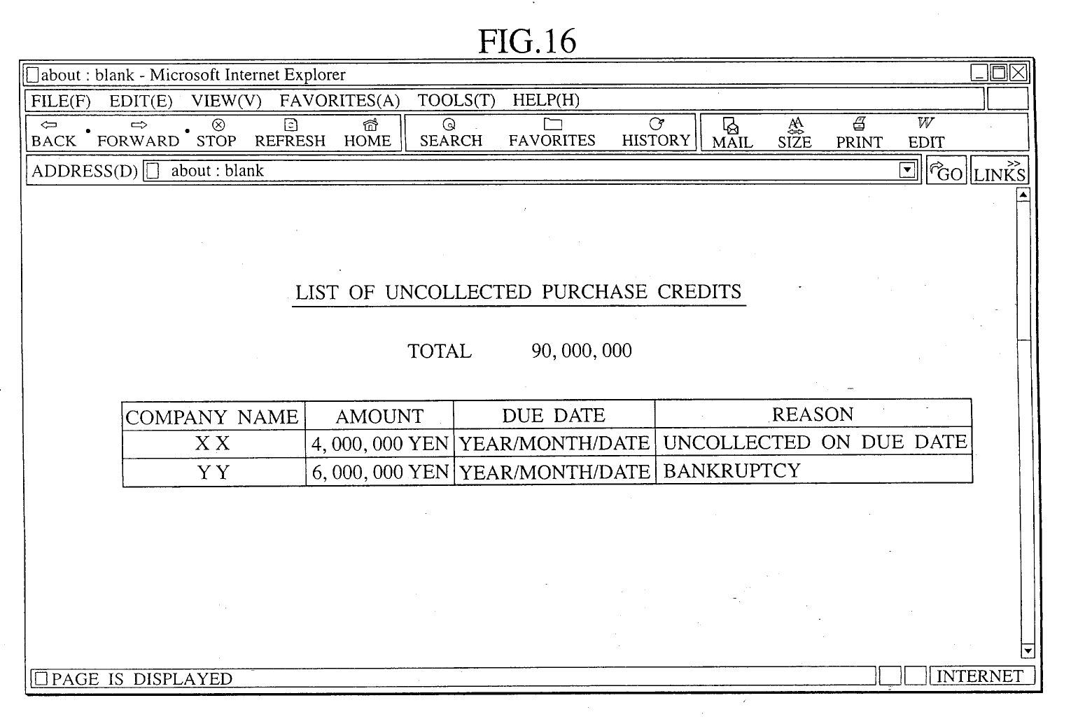

Then, upon having received the notice of non-receipt of money, the factoring commission apparatus 5 notifies a credit buying-back request to the supplier (S625). Upon having received such notice, the supplier verifies uncollected credits on a list screen shown in FIG. 16 (S626), and transmits an instruction of remitting funds for collecting the uncollected credits to the supplier specified financial institution 10 (S627).

Then, based on the fund-remittance instruction, the supplier specified financial institution 10 remits an amount of money for the uncollected credits to the purchase financial institution 6 (S628). Thus, the processing of the uncollected credits is completed, and the factoring on commission by the factoring commission apparatus 5 is finished.

As described above, the factoring commission system 1 of the embodiment is configured such that the factoring commission apparatus 5 totals charge detail information and generates factoring target data for each supplier. Thus, it is possible to greatly reduce the burden of data processing for factoring imposed on the supplier.

In addition, the supplier can select a purchase financial institution from a number of financial institutions by specifying a factoring condition. Thus, it is possible to make factoring requests to many financial institutions.

Therefore, in accordance with the factoring commission system 1 of the embodiment, the supplier can efficiently change sales credits into funds.

The example of transactions on the portal site has been described. Even in electronic business transactions on an e-marketplace, a Web-EDI or the like, the factoring commission system of the embodiment can perform factoring on commission.

Furthermore, the embodiment has been described by way of example of sales credit selling. However, the factoring commission system of the embodiment can process even credit granting from a financial institution on security of sales credits as in the case of sales credits selling.

(Second Embodiment)

Hereinafter, description will be made for a factoring commission system according to a second embodiment of the present invention with reference to the accompanying drawings.

1. System Configuration

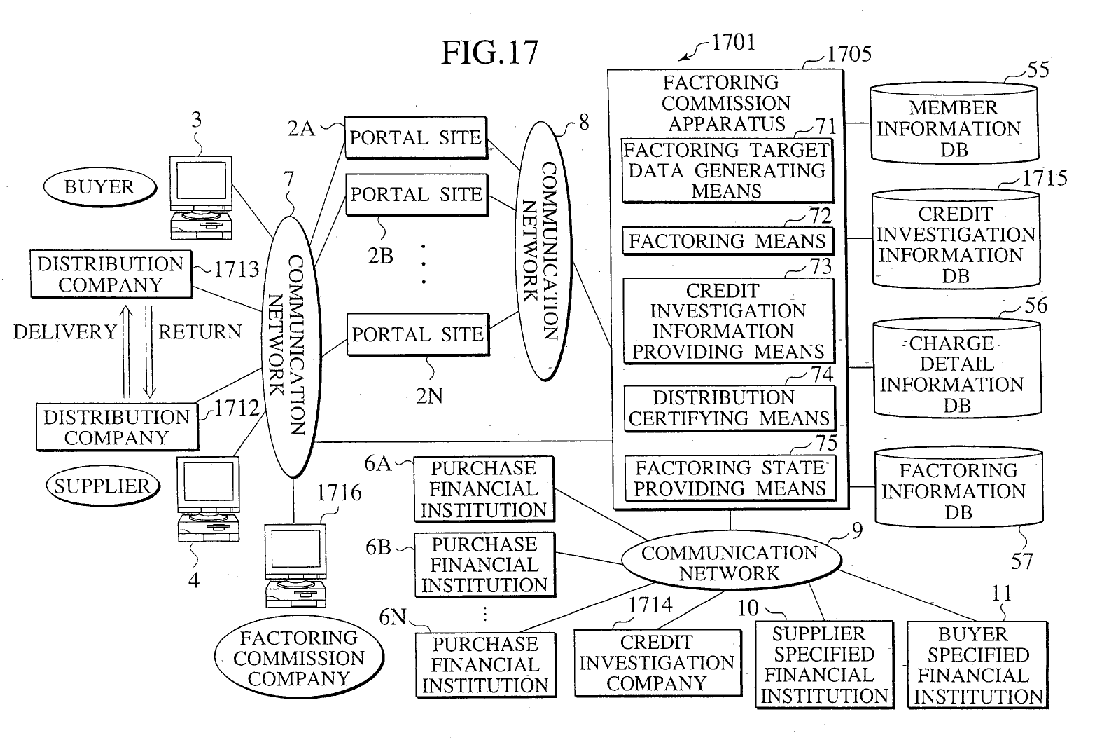

First, description will be made for a configuration of the factoring commission system of the embodiment by referring to FIG. 17. However, components similar to those of the first embodiment are denoted by similar reference numerals, and detailed description thereof is omitted.

As shown in FIG. 17, a factoring commission system 1701 of the present embodiment includes: a buyer terminal 3 of a buyer company for buying goods by accessing portal sites 2A, 2B, . . . , and 2N; a supplier terminal 4 of a supplier company for supplying goods information to the portal sites 2A, 2B, . . . , and 2N; a factoring commission apparatus 1705 functioning as a server to execute factoring on commission based on sales credits generated by transactions between the supplier and the buyer; purchase financial institutions 6A, 6B, . . . , and 6N for buying the sales credits generated by the sales transactions; a supplier specified financial institution 10 specified by the supplier as a receiver of money paid for the sales credits; a buyer specified financial institution 11 specified by the buyer as a receiver of accounts receivable; a distribution company 1712 for delivering goods upon reception of a request from the supplier; a distribution company 1713 for returning goods upon reception of a request from the buyer; a credit investigation company 1714 for investigating credit of a company and supplying credit investigation information; and a management terminal 1716 of a factoring commission company for managing factoring on commission carried out by the factoring commission apparatus 1705.

In this case, the buyer terminal 3, the supplier terminal 4, the portal sites 2A, 2B, . . . , and 2N, the distribution companies 1712 and 1713, the management terminal 1716 and the factoring commission apparatus 1705 are interconnected by the communication network 7. The portal sites 2A, 2B, . . . , and 2N and the factoring commission apparatus 1705 are interconnected by a communication network 8. The factoring commission apparatus 1705, the financial institutions 6A, . . . , 6N, 10 and 11 and the credit investigation company 1714 are interconnected by a communication network 9. The communication networks 7, 8 and 9 are composed of communication lines such as the Internet, dial-up, a dedicated line, VPN and a radio connection. Especially, connection is made in the communication network 8 based on protocol of TCP/IP or SAP R3, and connection is made in the communication network 9 based on Zengin protocol (Standard Communication Protocol of Japanese Bankers Association) or a SWIFT format in overseas remittance.

Further, the factoring commission apparatus 1705 includes factoring target data generation means 71 for receiving charge detail information as information regarding a bill of charges generated by transactions on the portal sites 2A, 2B, . . . , and 2N, and generating factoring target data to be subjected to factoring from the charge detail information based on a condition specified by the supplier, factoring means 72 for transmitting the factoring target data generated by the factoring target data generation means 71 to a purchase financial institution 6, and causing the purchase financial institution 6 to extract a purchasable sales credit from the factoring target data and remit a payment for the purchasable sales credit to the supplier specified financial institution 10, a credit investigation information provider 73 for providing credit investigation information regarding credit of a company, distribution certifying means 74 for presenting a distribution certificate certifying that transacted goods have been delivered by the distribution company, and factoring state providing means 75 for providing information regarding a sales credit coincident with a factoring state search condition, when the factoring state condition for searching a factoring state is entered.

The factoring commission apparatus 1705 is a server composed of a general computer system including a CPU for executing various processing operations and a storing means for storing commands of the operations, managed by a so-called Internet provider, and connected through the Internet to a not-shown host computer. When access is made by the buyer terminal 3 or the supplier terminal 4 through the communication network 7 or 8, the factoring commission apparatus 1705 provides a home page directed to the buyer or the supplier. On this home page, information regarding an inquiry of the factoring target data or a result of factoring is displayed.

In addition, the factoring commission apparatus 1705 includes: a member information database 55 for storing member information of a buyer or a supplier as a member of the factoring commission system 1701; a charge detail information database 56 for storing charge detail information as information regarding a bill of charges generated by transactions on the portal sites 2A, 2B, . . . , and 2N; a factoring information database 57 for storing information necessary for factoring such as the factoring target data; and a credit investigation information database 1715 for storing credit investigation information provided from the credit investigation company 1714.

Here, the credit investigation information database 1715 stores the credit investigation information for all types of companies provided from a credit investigation company such as Teikoku Data Bank or Tokyo Shoko Research.

2. Operation

Next, description will be made for each processing carried out by the factoring commission system 1701 of the present embodiment with reference to the accompanying drawings.

2-1. Member Information Registration

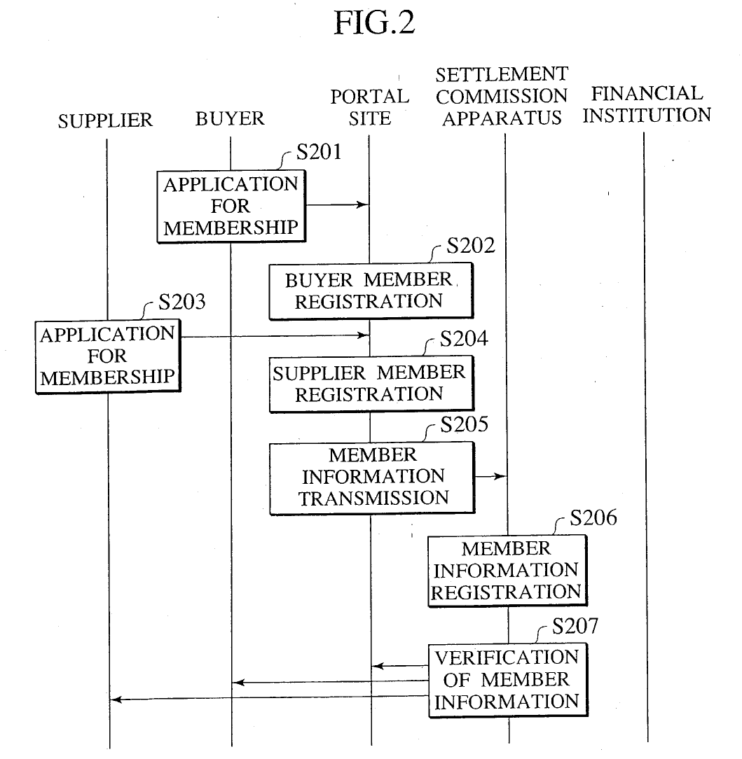

Member information registration of a buyer and a supplier by the factoring commission system 1701 of the second embodiment is similar to that of the first embodiment shown in FIG. 2, and thus description thereof is omitted.

2-2. Sales Transaction of Goods on Portal Site

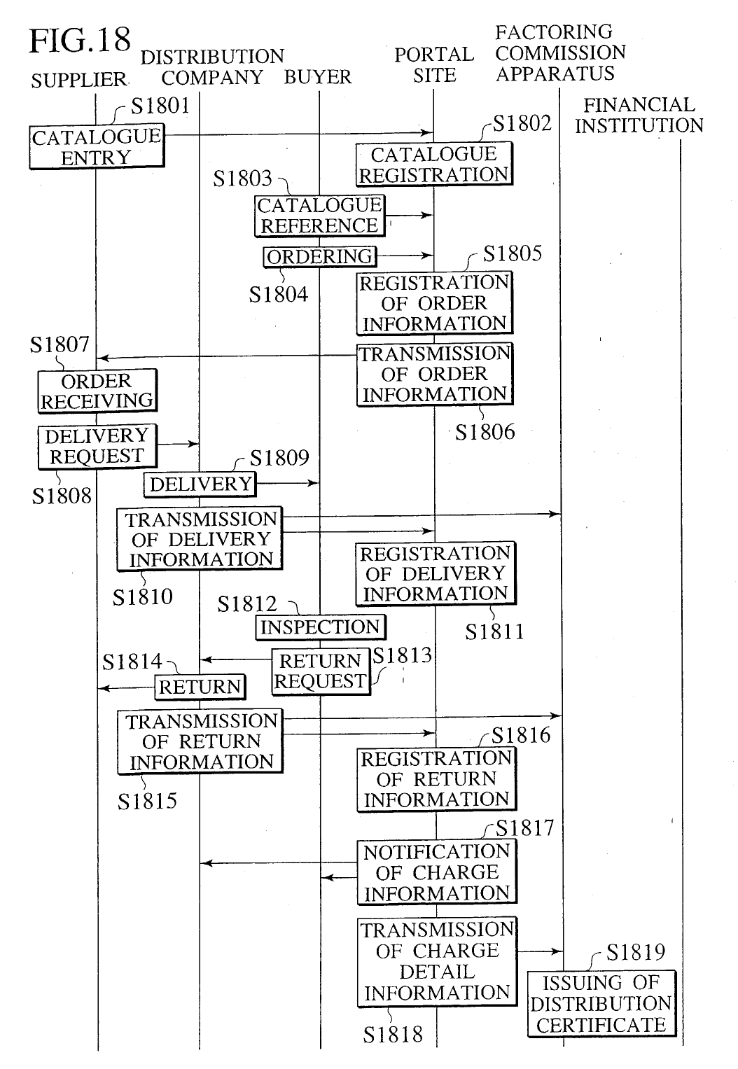

Next, description will be made for sales transactions on the portal site 2 based on a flowchart of FIG. 18.

First, the supplier accesses the portal site 2 from the supplier terminal 4, and writes goods to be sold in a catalogue of the portal site 2 (S1801). Upon reception thereof, the portal site 2 registers the goods in the catalogue (S1802).

Then, the buyer accesses the portal site 2 from the buyer terminal 3, and refers to the catalogue (S1803). When there are goods that the buyer wants to buy, the buyer sends an order to the portal site 2 (S1804). Upon reception of the order, the portal site 2 receives and resisters order information thereof (S1805).

Then, the order information is transmitted to the supplier terminal 4 of the supplier (S1806). The supplier receives the order based on the order information (S1807), and transmits a delivery request to the distribution company 1712 (S1808).

Upon having received the delivery request, the distribution company 1712 delivers goods to the buyer (S1809), and transmits delivery information to the portal site 2 and the factoring commission apparatus 1705 (S1810). In this case, the distribution company 1712 issues a distribution certificate certifying delivery by using a third-party certification organization such as Verisign, and transmits the distribution certificate with the delivery information.

Then, upon having received the delivery information, the portal site 2 registers the delivery information (S1811).

On the other hand, the buyer having received the goods inspects the delivered goods (S1812), and transmits a request of returning the goods to the distribution company 1713 if the goods are defective (S1813).

Then, upon having received the return request, the distribution company 1713 returns the goods to the supplier (S1814), and transmits return information to the portal site 2 and the factoring commission apparatus 1705 (S1815). In this case, the distribution company 1713 issues a distribution certificate certifying the return of goods by using a third-party certification organization such as Verisign, and transmits the distribution certificate with the return information.

Then, the portal site 2 registers the return information (S1816).

After the registration of the delivery information and the return information at the portal site 2, the portal site 2 generates charge information based on the delivery information and the return information, and notifies such charge information to both of the supplier and the buyer (S1817).

In this case, the supplier and the buyer can download the notified charge information on an XML file format.

In accordance with the XML file format, since information can be given a meaning and structured bit by bit by using a tag, the information can be easily incorporated into a system. The above case utilizes this advantage.

Thus, the supplier and the buyer can easily incorporate the data of charge information into systems of the companies, and also can effectively use the data of the notified charge information in deleting or accounting processing of selling.

Then, the portal site 2 extracts information necessary for settlement from the charge information to generate charge detail information, and transmits the charge detail information to the factoring commission apparatus 1705 (S1818), thus completing the sales transaction of the goods on the portal site 2.

The factoring commission apparatus 1705 can extract necessary information from the charge detail information based on tags by receiving the charge detail information on the XML file format. Thus, processing into factoring information is facilitated.

If the charge detail information contains an error or unnecessary information, then the portal site 2 transmits charge detail information having a control ID added to indicate a status such as a change or deletion to the factoring commission apparatus 1705. The factoring commission apparatus 1705 specifies a bill based on a bill number, and executes updating, deleting or the like in accordance with the status of the control ID.

When the distribution company 1712 or 1713 issues no distribution certificates in steps S1810 or S1815, the factoring commission apparatus 1705 issues a distribution certificate by using a third-party certification organization such as Verisign based on the delivery information and the return information (S1819).

2-3. Factoring on Commission

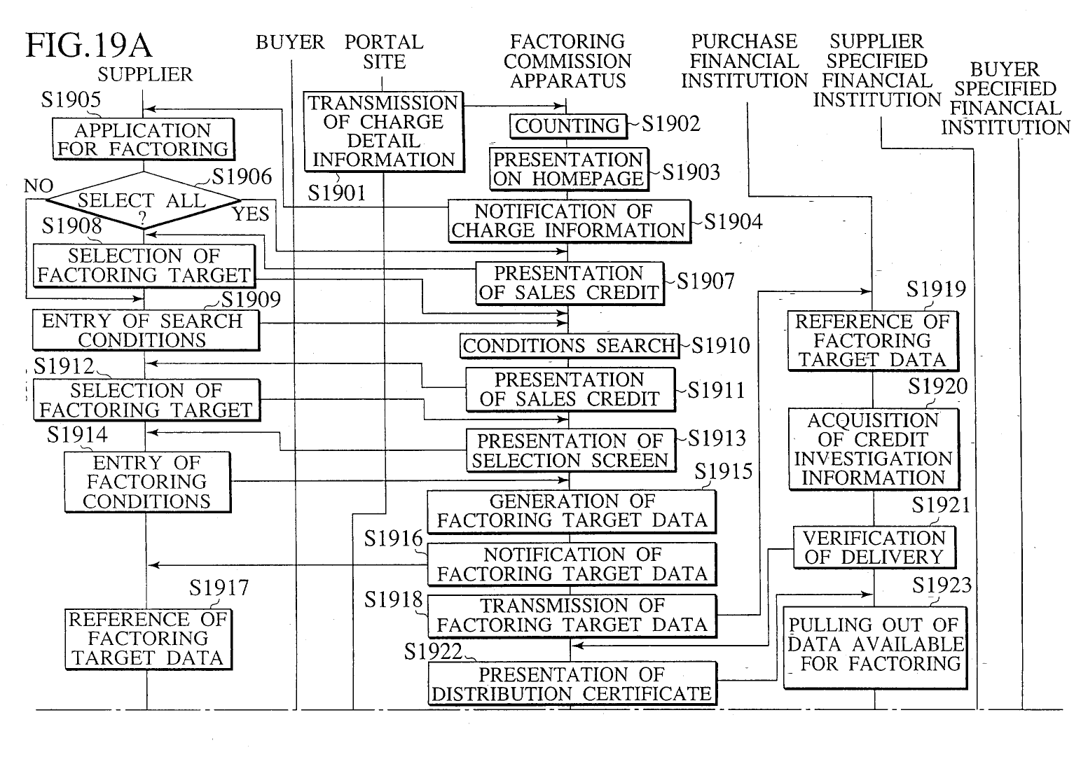

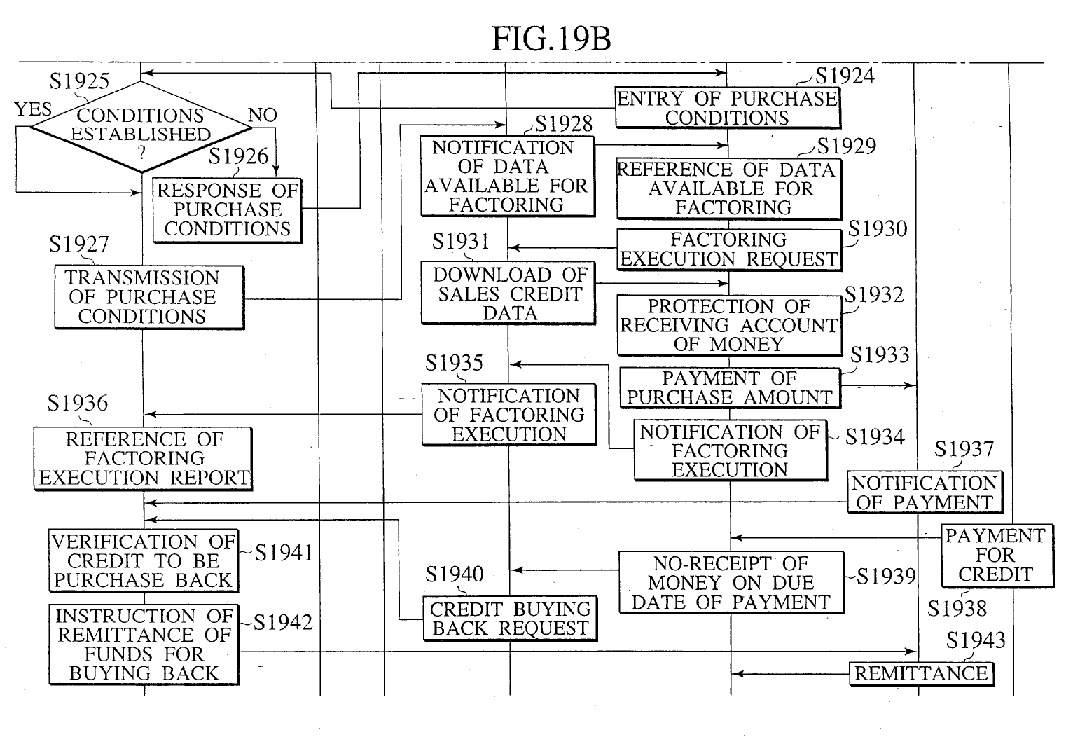

Next, description will be made for factoring on commission by the factoring commission apparatus 1705 of the embodiment based on a flowchart of FIGS. 19A and 19B.

As shown in FIGS. 19A and 19B, when charge detail information is transmitted from the contracted portal site 2A, 2B, . . . , or 2N (S1901), the factoring commission apparatus 1705 receives the charge detail information, and stores the same in the charge detail information database 56.

Then, the factoring commission apparatus 1705 periodically reads the charge detail information stored in the charge detail information database 56, executes monthly or weakly counting for individual suppliers (S1902), presents a content of a bill for each supplier based on the counting on the home page for the suppliers (S1903), and notifies the content of the bill to the supplier by electronic mail or the like (S1904).

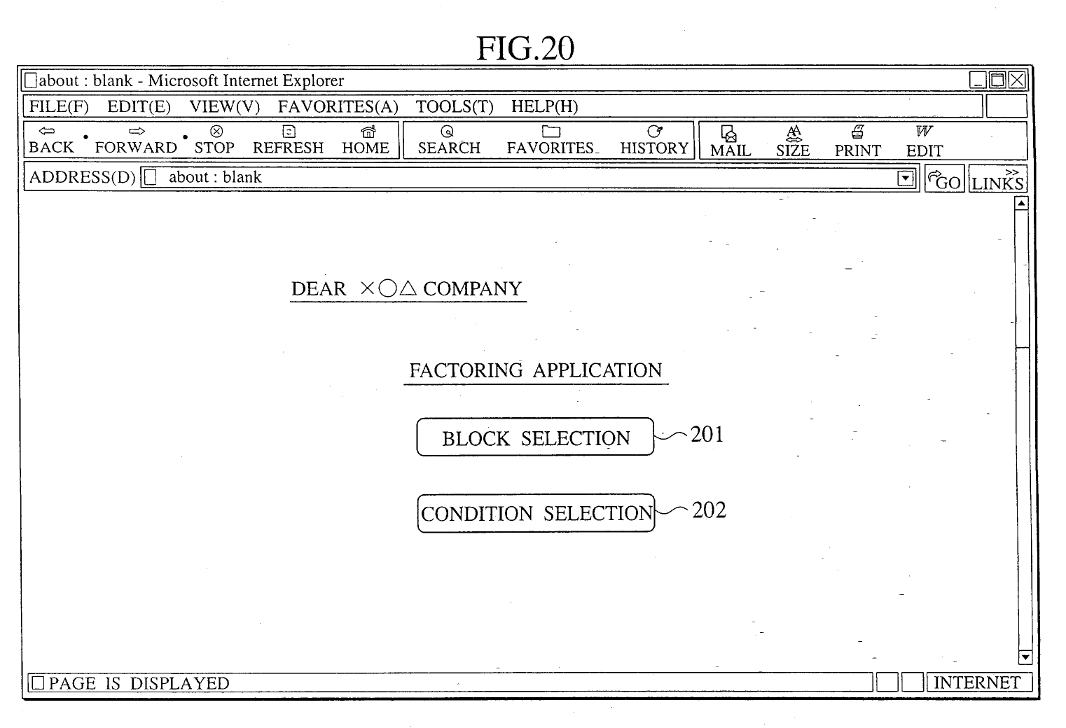

Upon having been notified of the bill, the supplier applies for factoring on an application screen similar to that shown in FIG. 20 (S1905). In this case, the supplier enters whether to select sales credits to be subjected to factoring in block for each bank of account or to decide sales credits to be subjected to factoring by condition search (S1906). In the case of batch selection, a “BLOCK SELECTION” button 201 is clicked on a screen of FIG. 20. In the case of condition search, a “CONDITION SEARCH” button 202 is clicked for entry.

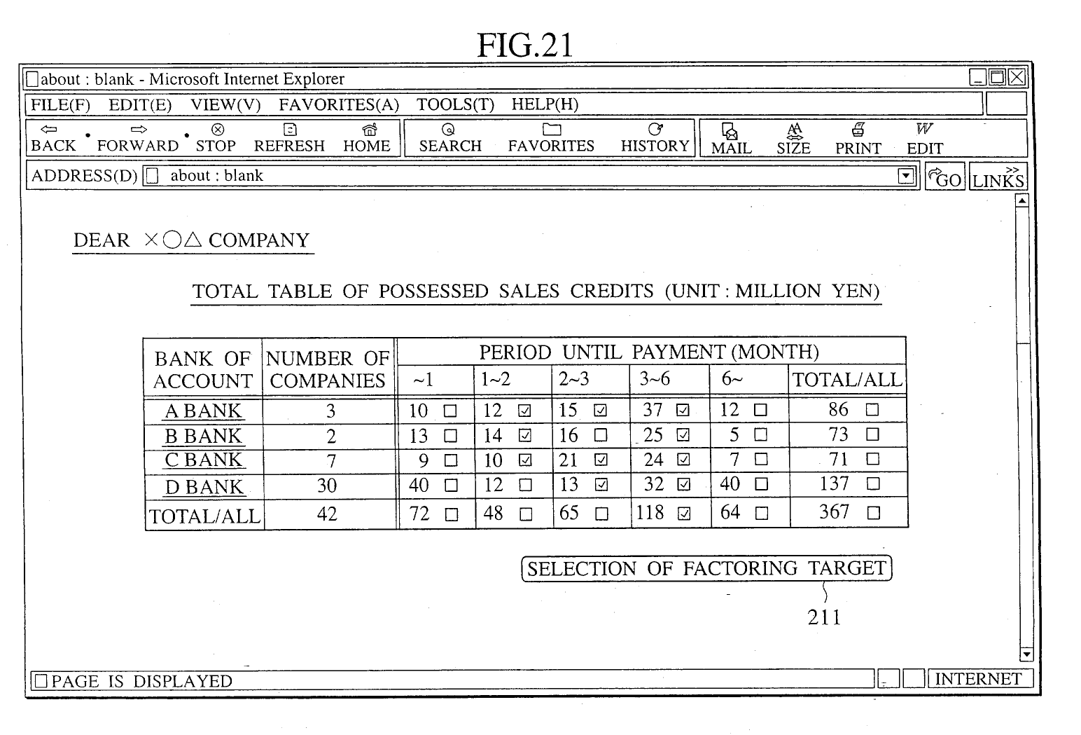

When the block selection is selected by the supplier, the factoring commission apparatus 1705 searches the charge detail information database 56, and extracts sales credits possessed by the supplier to show a total table of sales credits similar to that shown in FIG. 21 (S1907). Then, information regarding the extracted sales credits is stored in the factoring information database 57.

In this case, the total table of sales credits in FIG. 21 shows a classification of sales credits possessed by xOΔ Company based on a period until payment and a bank of account, and each total amount of sales credits is shown. A check box is provided in a section of each amount of money and, by clicking this check box, the supplier can select sales credits to be subjected to factoring. In addition, the supplier can add bills generated by transactions other than those on the portal site to the table of FIG. 21.

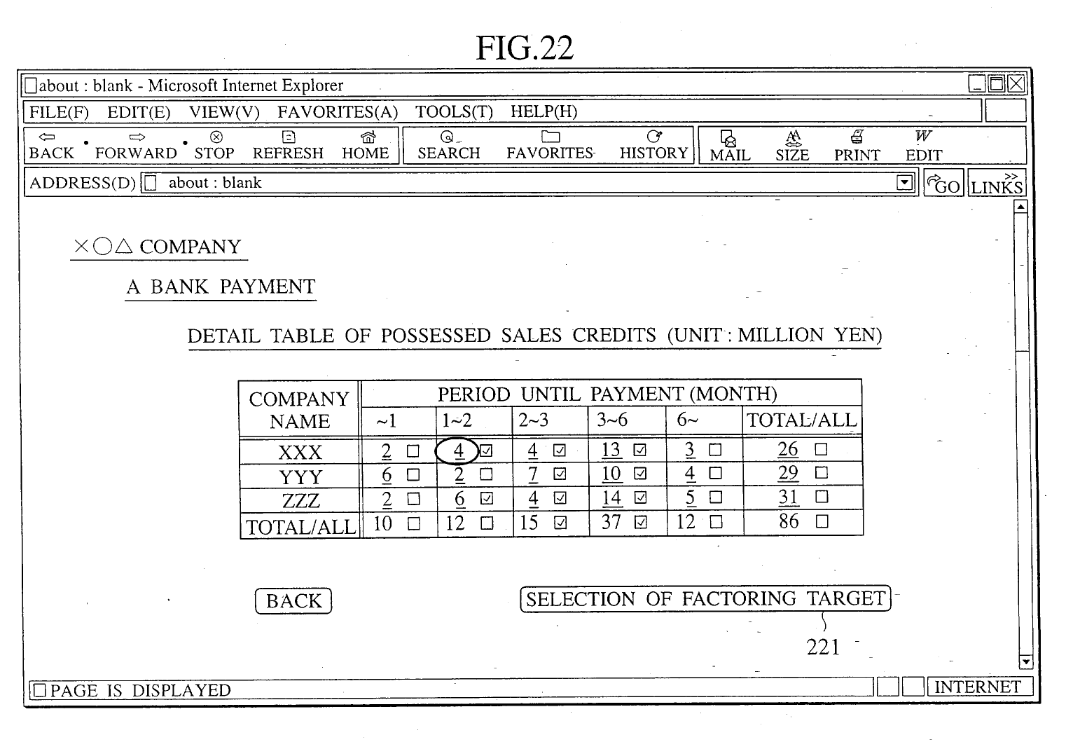

In this case, when a bank A is clicked on the screen of FIG. 21, a detail table of sales credits similar to that shown in FIG. 22 is displayed, and sales credits transacted with the bank A set as a bank of account are shown for each buyer.

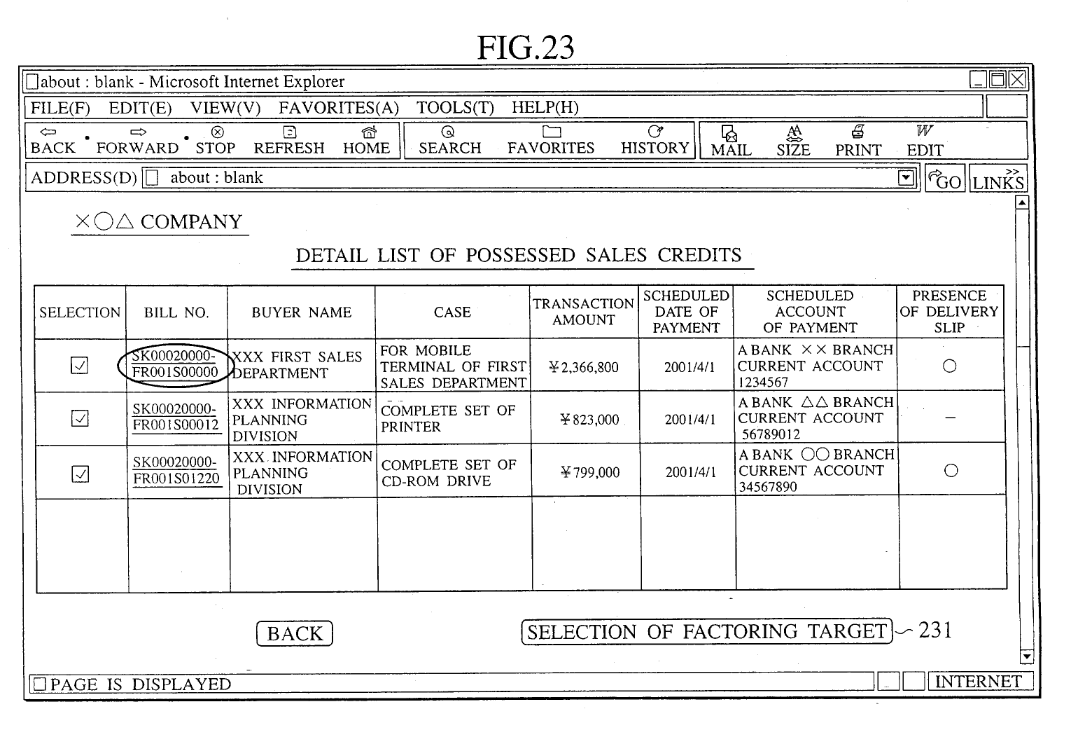

Further, when a displayed amount of money is clicked on the screen of FIG. 22, a detail of sales credits similar to that shown in FIG. 23 is displayed in detail. For example, “4” shown in a section of a buyer company “XXX” and a period until payment from 1 to 2 months is clicked on the screen of FIG. 22, a detail of sales credits similar to that shown in FIG. 23 is displayed in detail. Similarly, by clicking a check box in a section of an amount of money on the screen of FIG. 22, the supplier can also select sales credits to be subjected to factoring.

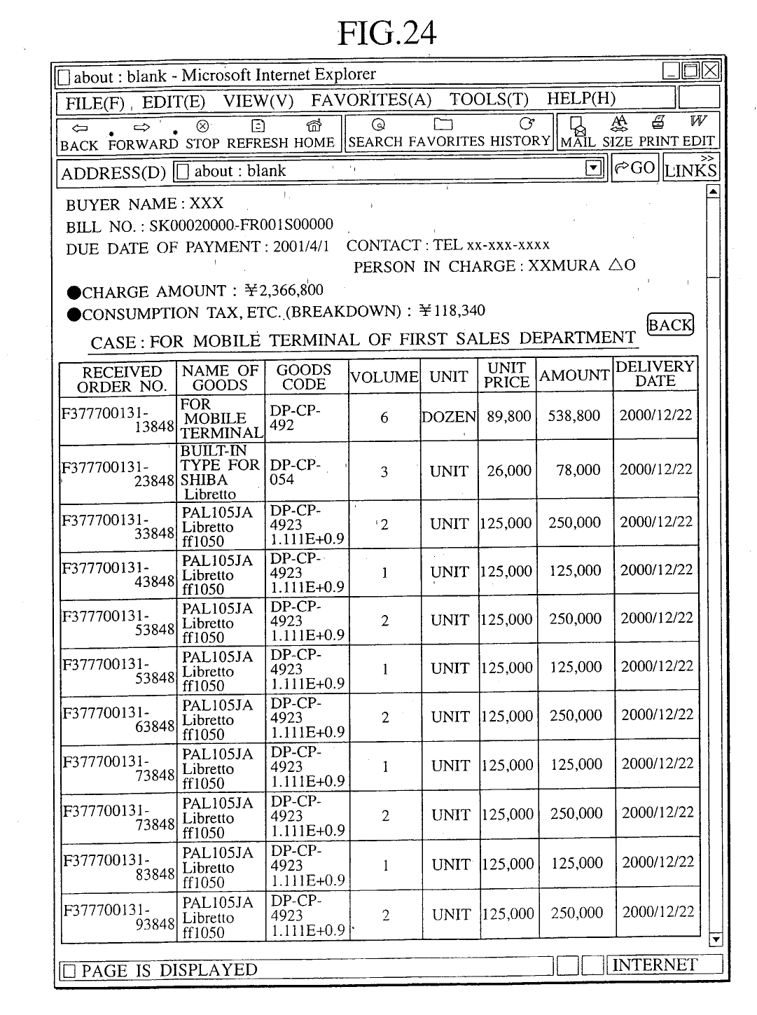

Further, a bill number is clicked on a screen of FIG. 23, a screen similar to that shown in FIG. 24 is displayed, and a meticulous detail of goods contained in a bill is shown. By clicking a check box in a selection section of FIG. 23, the supplier can select sales credits to be subjected to factoring.

Thus, after the presentation of the information regarding sales credits on the screens similar to those of FIGS. 21 to 24, the supplier refers to the information and clicks the check boxes on the screens of FIGS. 21 to 24 to select sales credits desired to be subjected to factoring. After all the sales credits are selected, the supplier clicks factoring target selection buttons 211, 221 and 231 of FIGS. 21, 22 and 23, and transmits a selection result of factoring targets to the factoring commission apparatus 1705 (S1908).

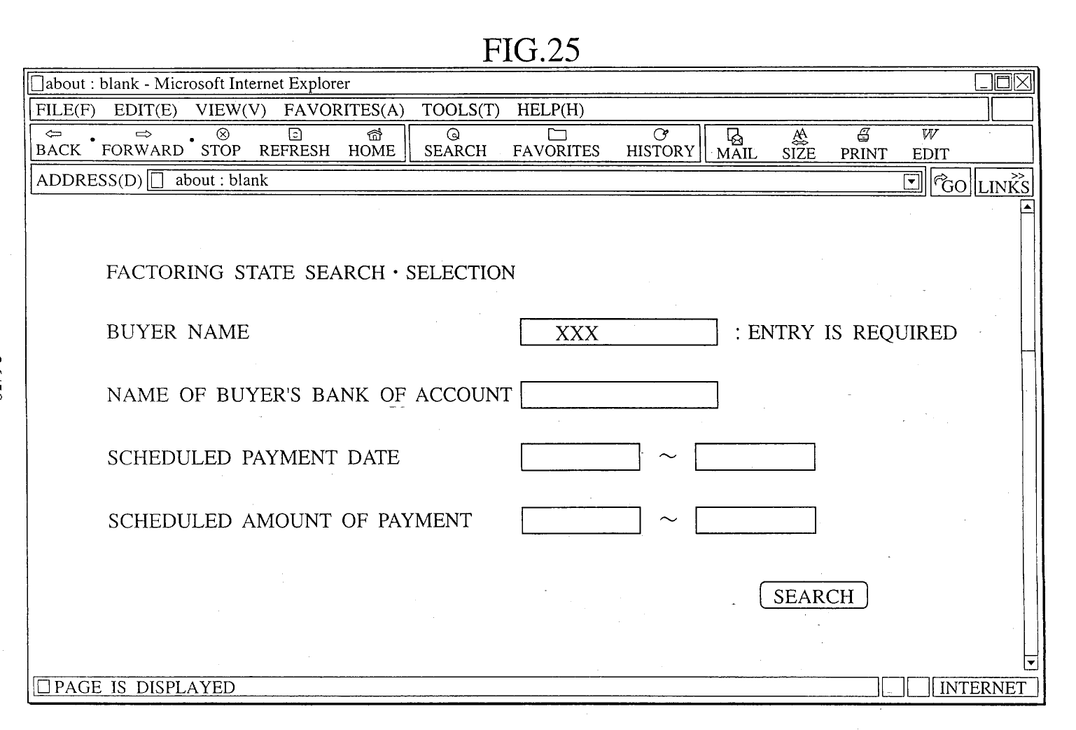

On the other hand, when the supplier selects the condition search in step S1906, a search condition for searching sales credits to be subjected to factoring is entered on an entry screen similar to that shown in FIG. 25 (S1909). On the entry screen of FIG. 25, a buyer company name as an essential item and other search conditions such as a bank of buyer's account, a scheduled date of payment, and scheduled amount of payment can be entered.

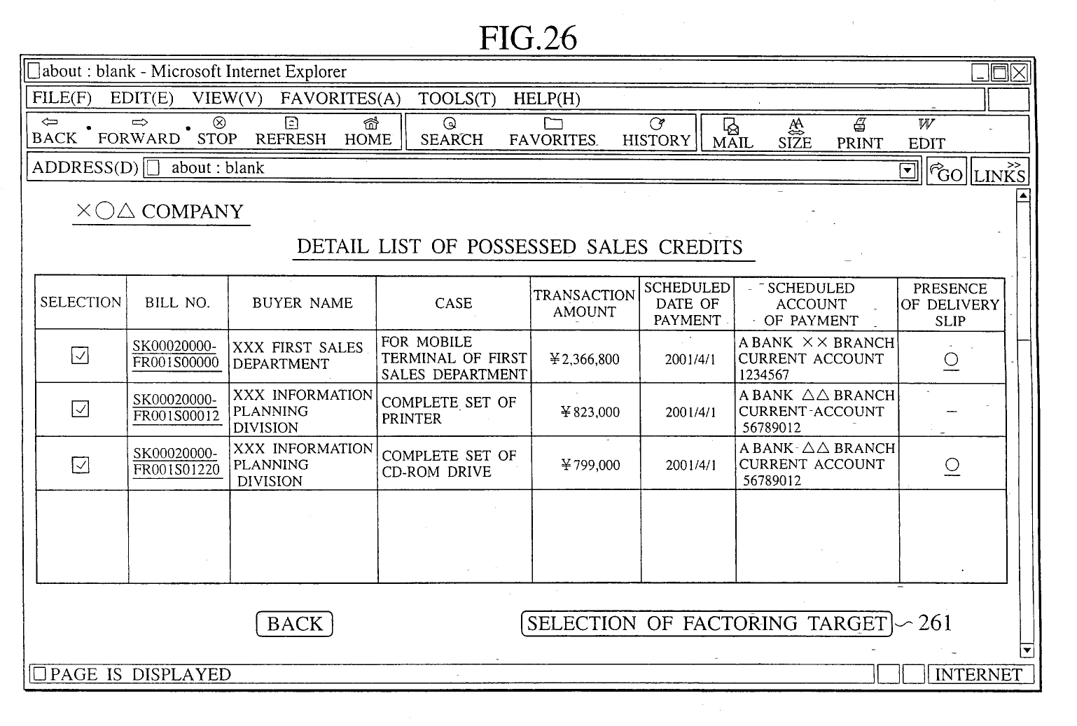

Then, the factoring commission apparatus 1705 searches the charge detail information database 56 based on the entered search conditions (S1910), extracts sales credits possessed by the supplier and coincident with the search conditions, and presents a detail of sales credits similar to that shown in FIG. 26 (S1911). Then, information regarding the extracted sales credits is stored in the factoring information database 57.

As described above, since sales credits can be searched by entering the search conditions, the supplier can easily select sales credits desired to be subjected to factoring.

Then, the supplier clicks a check box on a screen of FIG. 26 to select sales credits desired to be subjected to factoring, clicks a factoring target selection button 261 after selection of all sales, and transmits a selection result of factoring targets to the factoring commission apparatus 1705 (S1912).

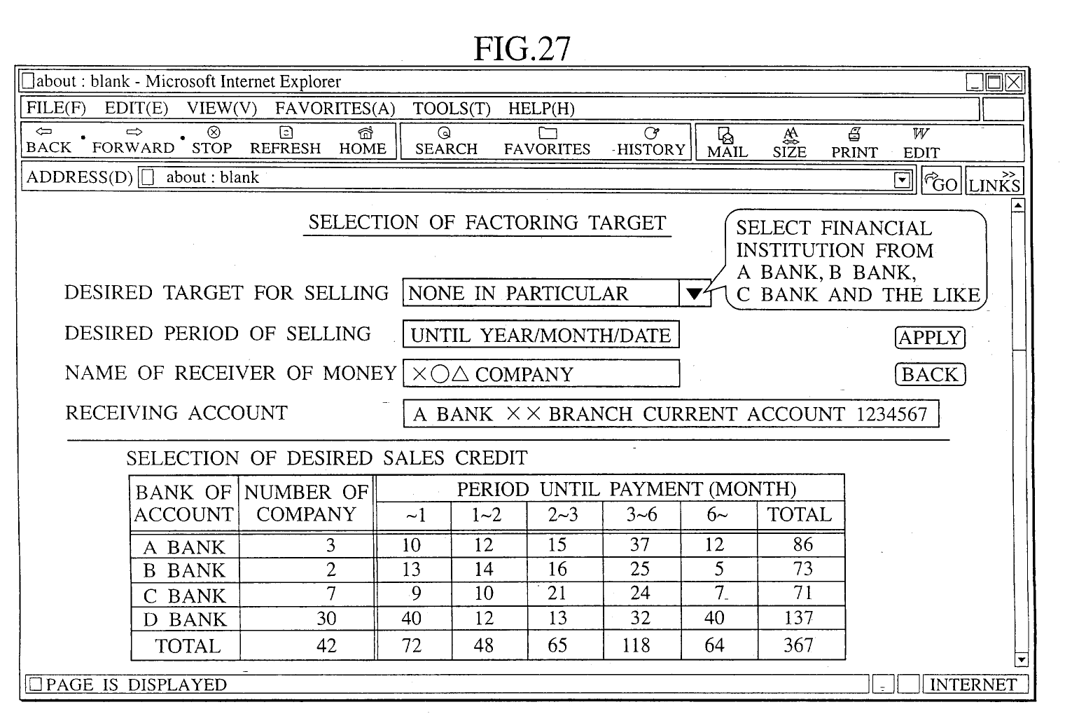

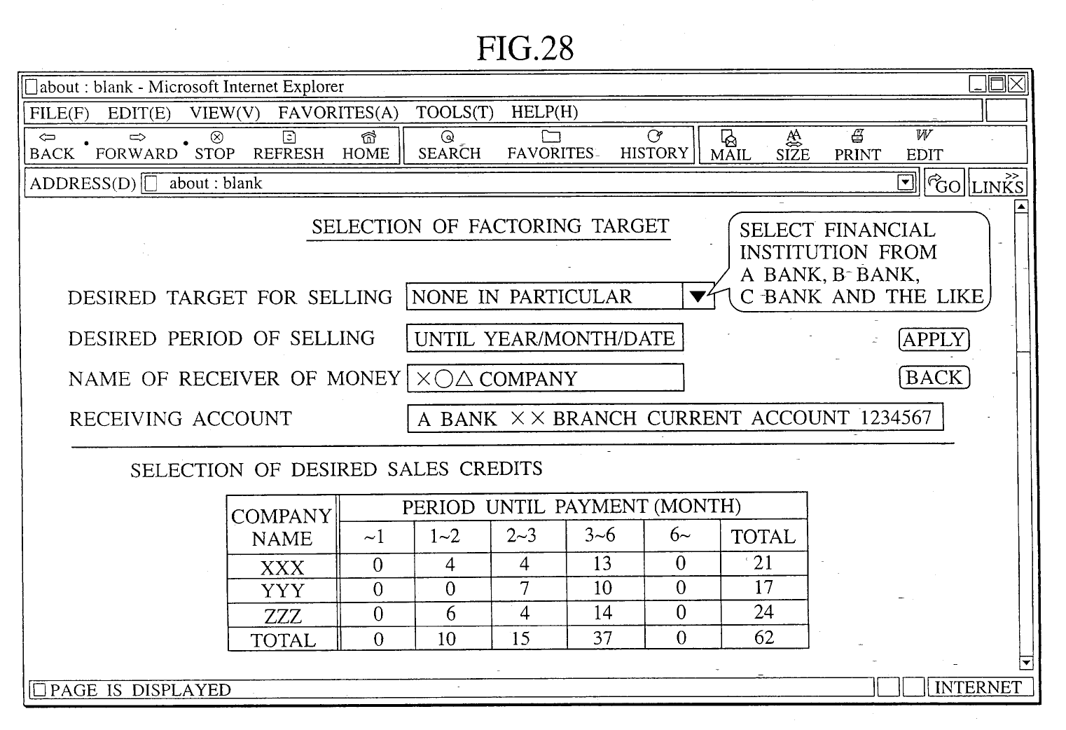

After the entry of the sales credits to be subjected to factoring in step S1908 or S1912, a selection screen for selecting a purchase financial institution as a factoring target is presented from the factoring commission apparatus 1705 (S1913). In this case, when the factoring target selection button is clicked on the screen showing the classification by the respective banks of account, similar to that shown in FIG. 21, a selection screen showing a classification of desired sales credits by the respective banks of account is presented as shown in FIG. 27. When the factoring target selection button is clicked on a screen showing the classification by the respective buyers, similar to that shown in each of FIGS. 22, 23 and 26, a selection screen showing a classification of desired sales credits by the respective buyers, similar to that shown in FIG. 28, is presented.

Then, the supplier enters factoring conditions such as a purchase financial institution as a desired buyer, a desired selling period, a name of a receiver of money and a receiving account on the screen of FIG. 27 or 28 (S1914).

As described above, since the supplier can specify factoring conditions, factoring can be carried out as desired by the supplier. Especially, since a purchase financial institution can be specified among a number of financial institutions, the supplier can make factoring requests to many financial institutions.

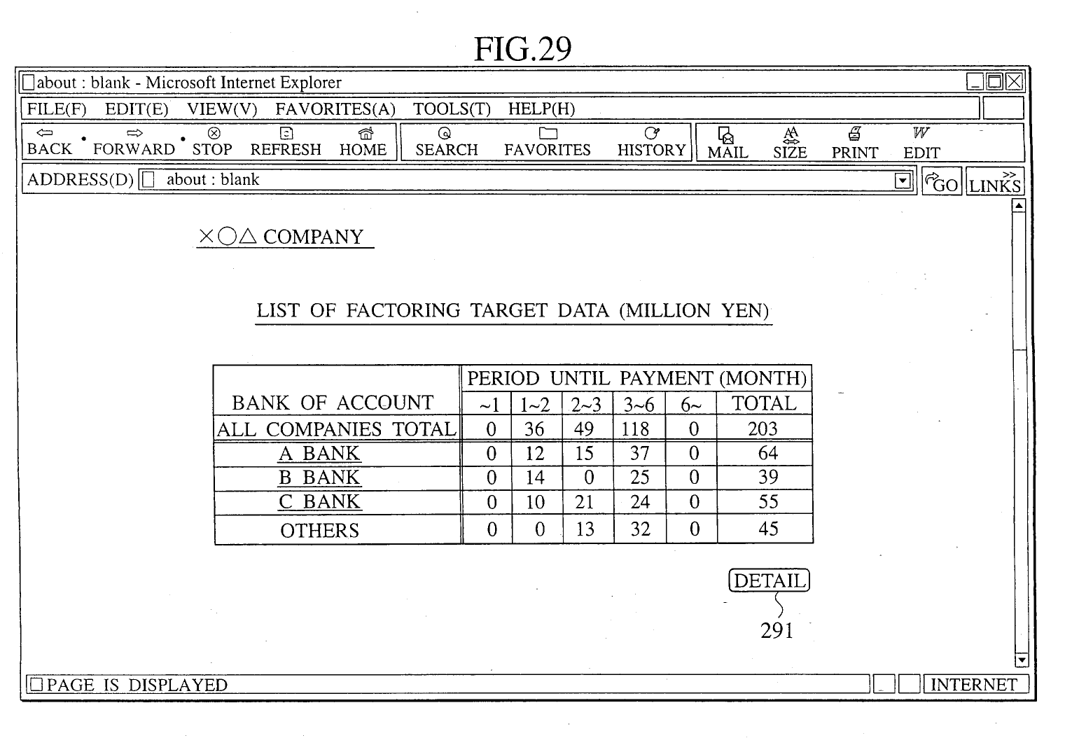

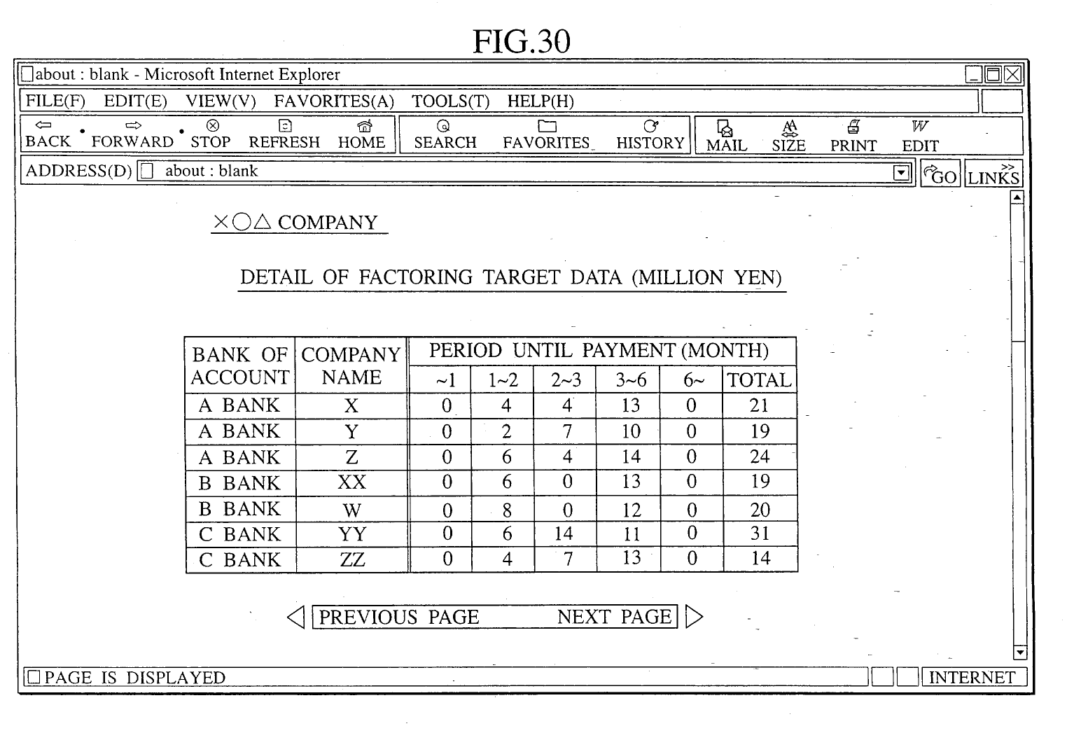

After the factoring conditions have been specified in the above-described manner, the factoring commission apparatus 1705 generates factoring target data to be subjected to factoring from desired sales credits selected by the supplier based on the factoring conditions (S1915). Then, the generated factoring target data is notified to the supplier (S1916), and the supplier having received such notice refers to the factoring target data on a list screen of factoring target data shown in FIG. 29 (S1917). In this case, by clicking a “DETAIL” button 291 on the list screen of FIG. 29, a detail of factoring target data for each company shown in FIG. 30 can be referred to.

On the other hand, the factoring commission apparatus 1705 also transmits the factoring target data to the purchase financial institution 6 for executing factoring (S1918).

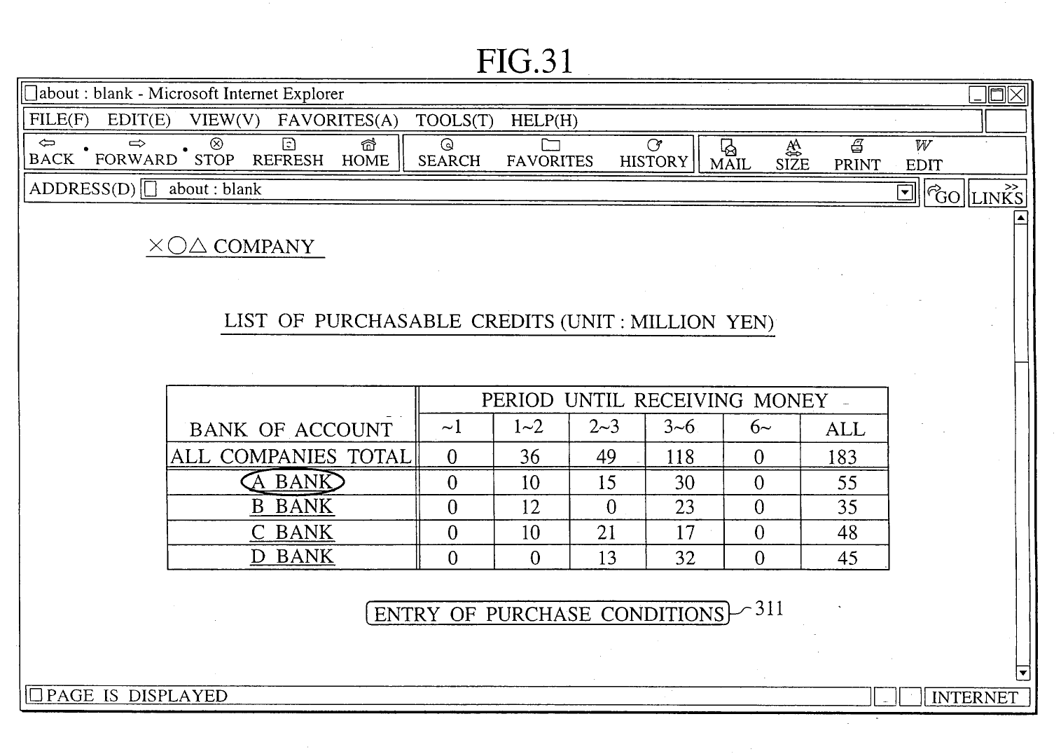

Upon having received the factoring target data, the purchase financial institution 6 refers to purchasable credits as the factoring target data on a list screen similar to that shown in FIG. 31 (S1919).

Here, a list of purchasable credits in FIG. 31 shows total amounts of money of sales credits, which are requested for factoring by xOΔ Company, in a classification by a period until receiving of money and a financial institution of account.

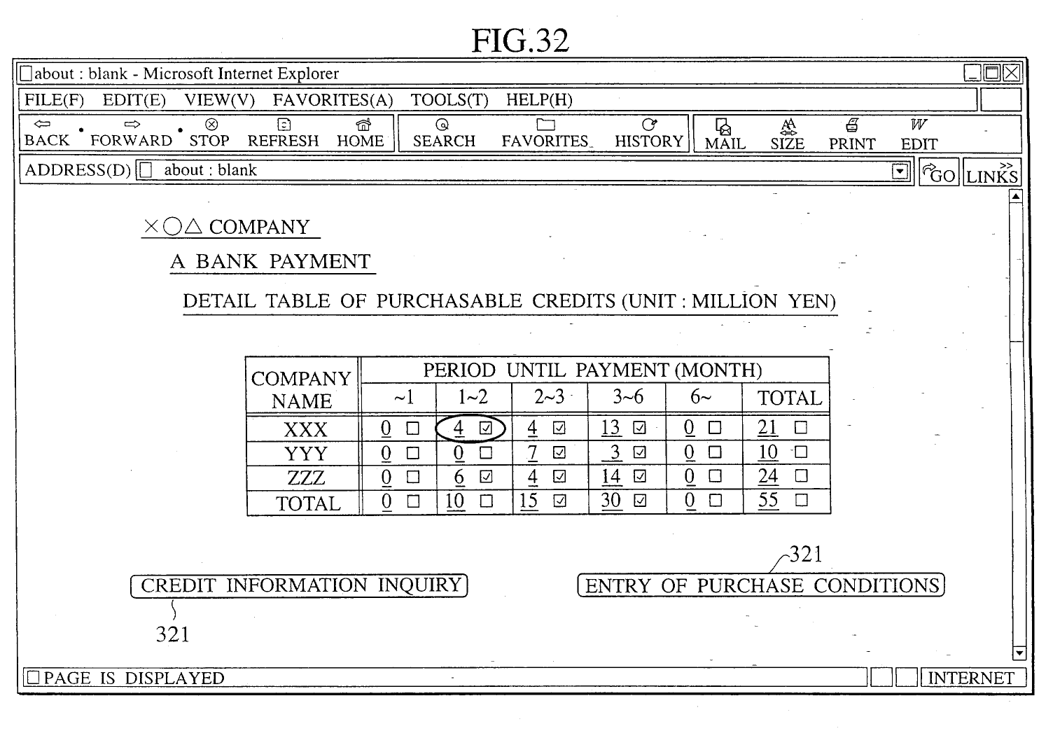

In this case, when a bank A is clicked on the screen of FIG. 31, a detail of purchasable credits, similar to that shown in FIG. 32, is displayed, and sales credits of buyers transacted through the bank A are displayed for each buyer.

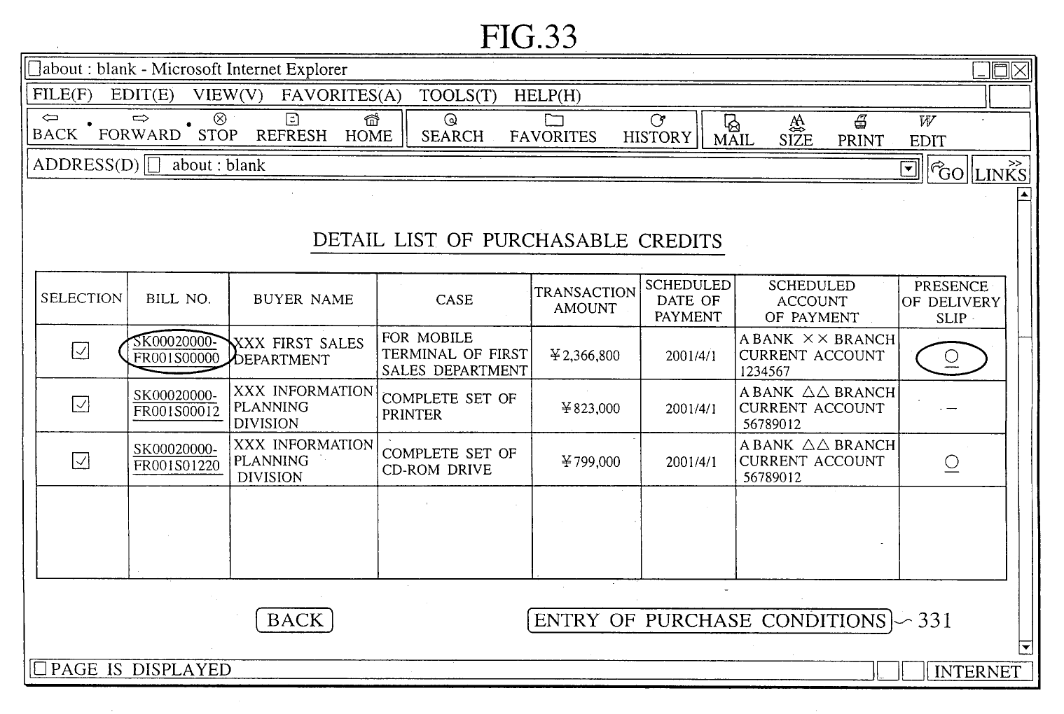

Further, when a displayed amount of money is clicked on a screen of FIG. 32, a detail of purchasable credits, similar to that shown in FIG. 33, is displayed. For example, “4” shown in a section of a buyer company “XXX” and a period until payment from 1 to 2 months is clicked on a screen of FIG. 32, a detail of sales credits similar to that shown in FIG. 33 is displayed in detail. Then, by clicking a check box in the section of an amount of money on the screen of FIG. 32, the purchase financial institution 6 can select sales credits to be bought.

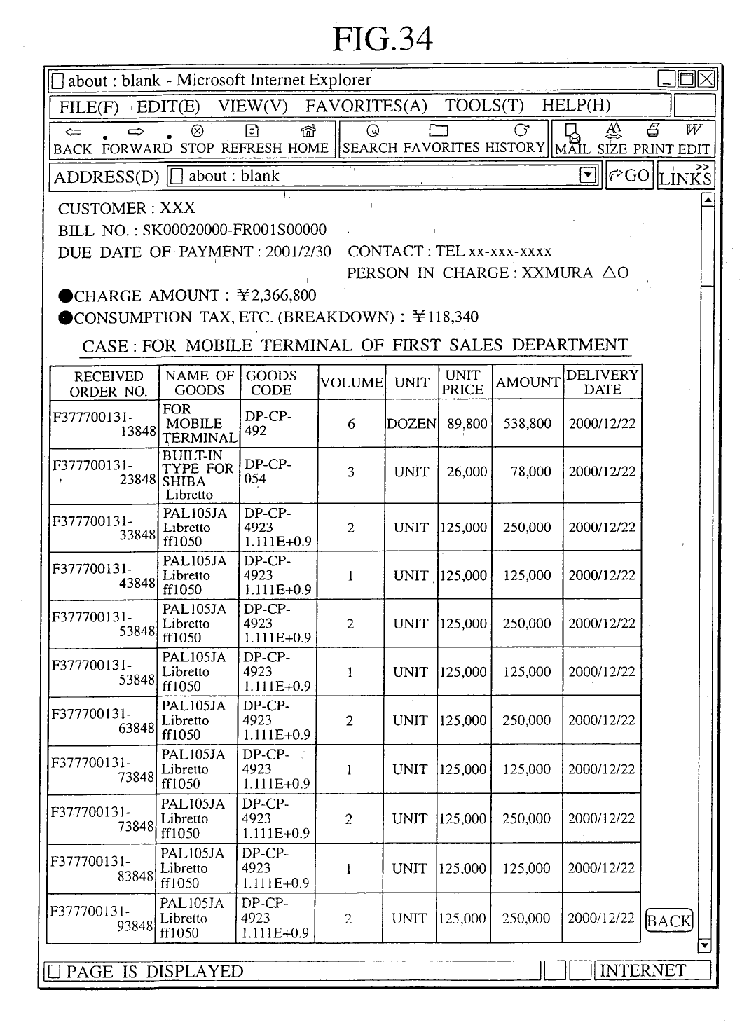

Further, when a bill number is clicked on a screen of FIG. 33, a screen similar to that shown in FIG. 34 is displayed, and a meticulous detail of goods contained in a bill is shown.

In addition, by clicking a check box in a selection section of the screen of FIG. 33, the purchase financial institution 6 can select sales credits to be bought.

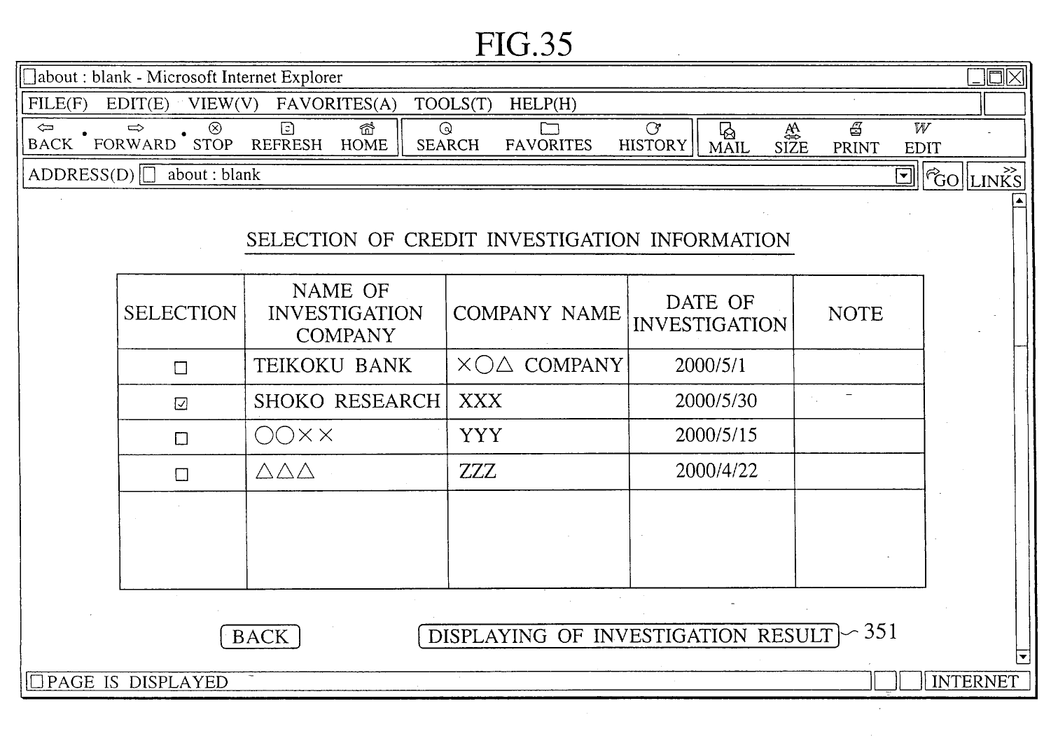

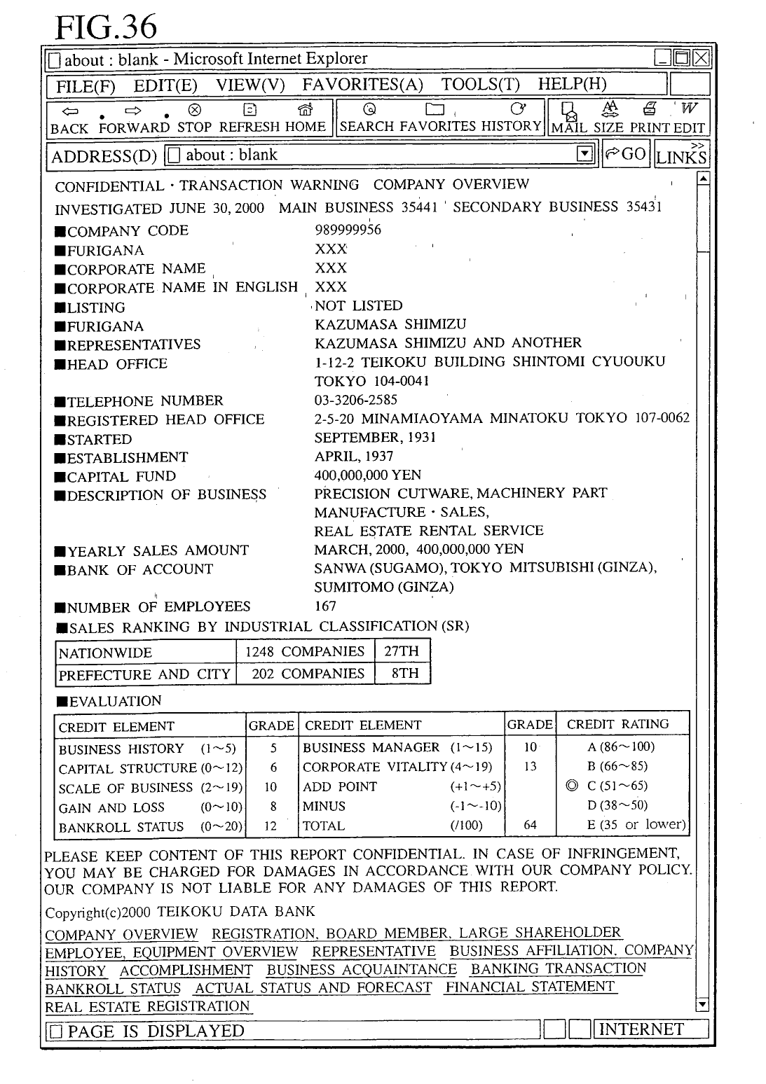

Thus, the purchase financial institution 6 extracts credits available for factoring by referring to the credits requested for factoring on the screen described above. In this case, however, since a credit rating of a buyer and a risk must be considered, the purchase financial institution 6 clicks a “CREDIT INFORMATION INQUIRY” button 321 in FIG. 32 to obtain credit investigation information (S1920). In this case, when the purchase financial institution 6 clicks the “CREDIT INFORMATION INQUIRY” button 321, a credit investigation information selection screen similar to that shown in FIG. 35 is displayed. When a check box in a selection section on this screen is clicked to select desired credit investigation information, and then an “INVESTIGATION RESULT DISPLAY” button 351 is clicked, an investigation result similar to that shown in FIG. 36 is displayed. Here, the credit investigation information may be obtained by accessing the credit investigation company 1714 through the Internet or the like. Alternatively, the credit investigation information obtained from the credit investigation company 1714 may be stored in the credit investigation information database 1715 beforehand, and then obtained by accessing this credit investigation information database 1715.

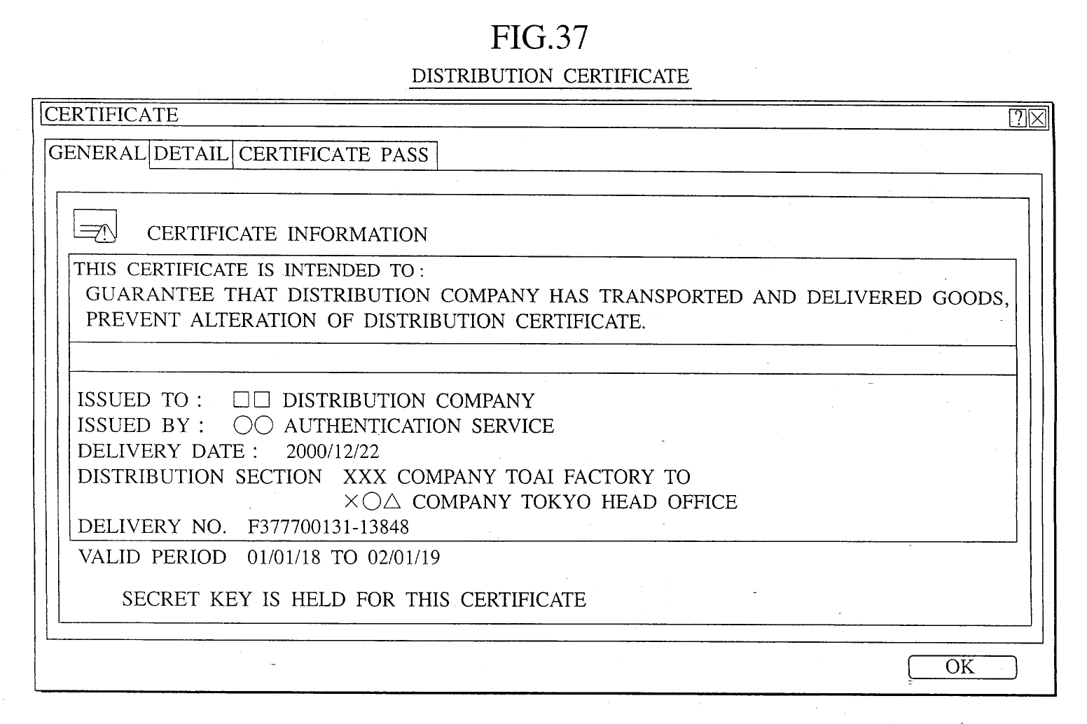

Further, when a mark “O” in a section of “PRESENCE OF DELIVERY SLIP” is clicked to verify delivery (S1921), a distribution certificate certifying whether the goods have actually been delivered or not, similar to that shown in FIG. 37, is presented by the factoring commission apparatus 1705 (S1922). This distribution certificate was issued in step S1810, 1815 or 1819, indicating information regarding a target for issuance, an issuance source, a delivery date, a distribution section, a delivery number, a valid period and the like, and guaranteeing that the distribution company has transported and delivered the goods.

Then, after having referred to the credit investigation information and the distribution certificate, the purchase financial institution 6 clicks the check box of FIG. 32 or 33 to extract credits available for factoring (S1923).

As described above, since the purchase financial institution 6 can extract the credits available for factoring by referring to the credit investigation information and the distribution certificate, the purchase financial institution 6 can buy the sales credits without any anxiety, making it possible to provide high security in factoring commission services in the factoring commission system 1710 of the embodiment.

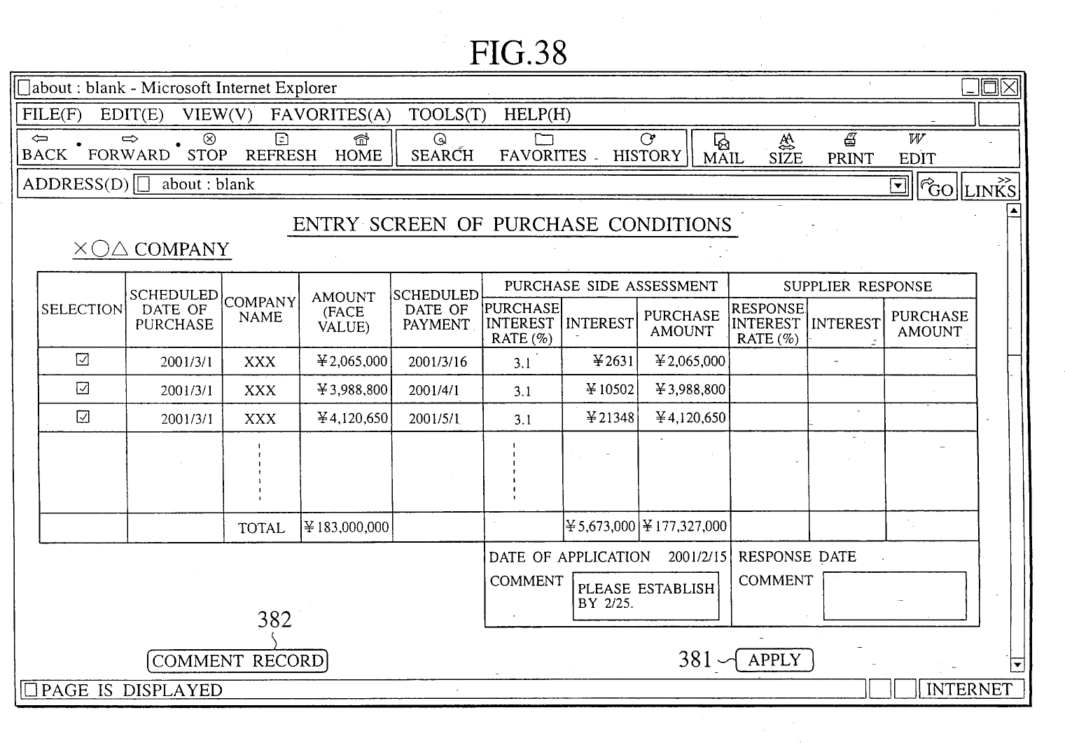

After the credits to be bought have been extracted by the purchase financial institution 6, and when “PURCHASE CONDITION ENTRY” buttons 311, 321 and 331 are clicked on the screen of FIG. 31, 32 or 33, an entry screen of purchase conditions similar to that shown in FIG. 38 is displayed. Then, the purchase financial institution 6 enters a purchase condition such as a purchase interest rate on the entry screen, and clicks an “APPLICATION” button 381 to apply for factoring (S1924). On the entry screen of FIG. 38, when the purchase financial institution 6 enters the purchase interest rate, an interest and a purchase amount are calculated based on the interest rate to be displayed.

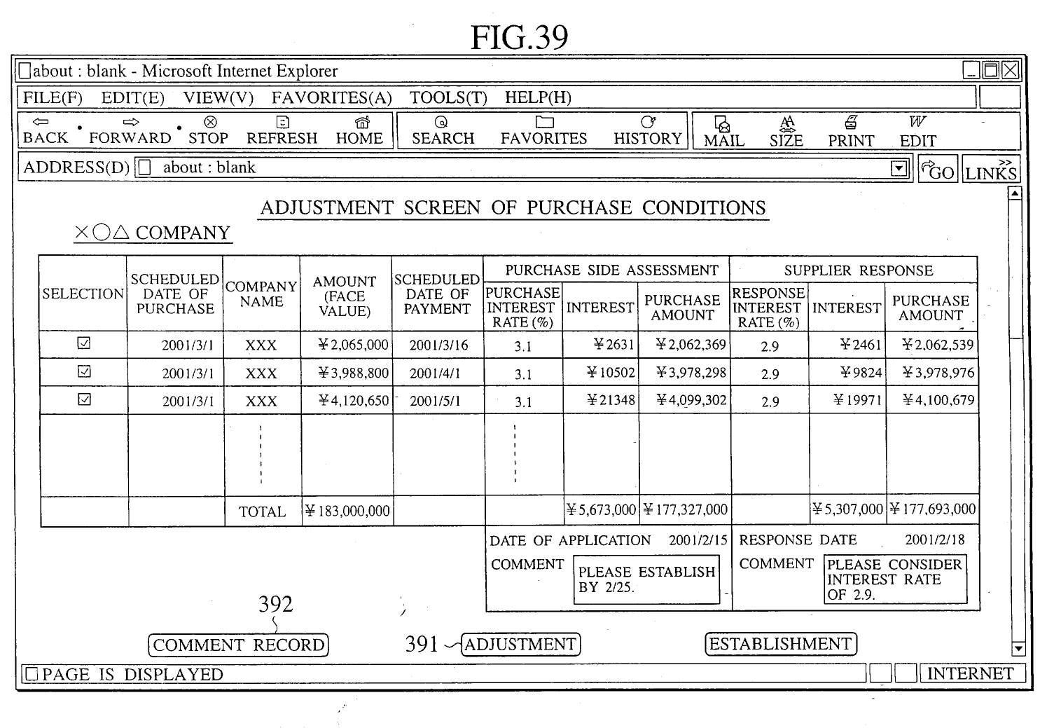

Upon having received the application for factoring, the supplier determines whether or not to accept the factoring based on the presented purchase interest rate (S1925). If the supplier wishes to adjust the purchase interest rate presented by the purchase financial institution 6, the supplier enters a response interest rate and clicks a “ADJUST” button 391 as shown in FIG. 39 (S1926).

Upon having received the response, the purchase financial institution 6 enters a purchase interest rate again and clicks an “APPLICATION” button 401 as shown in FIG. 39 (S1924).

Upon having received the above application, the supplier determines whether or not to accept the factoring based on the presented purchase interest rate again (S1925). In the case of acceptance, the supplier clicks an “ESTABLISH” button 411 to establish a purchase condition, and the established purchase condition is transmitted to the factoring commission apparatus 1705 (S1927).

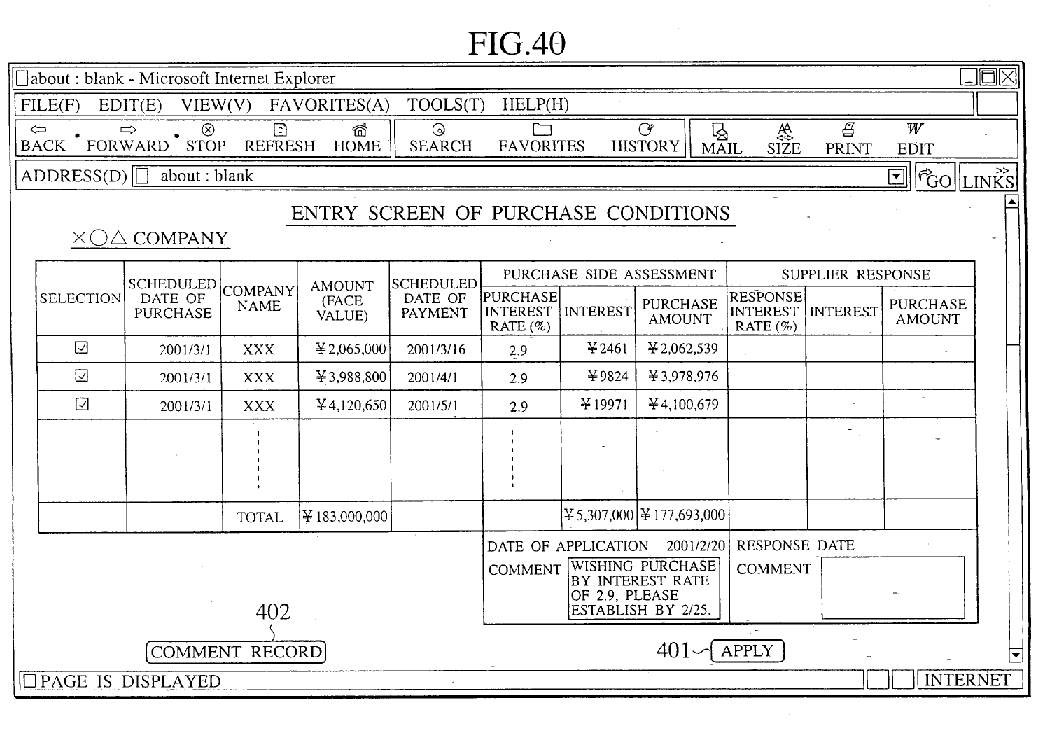

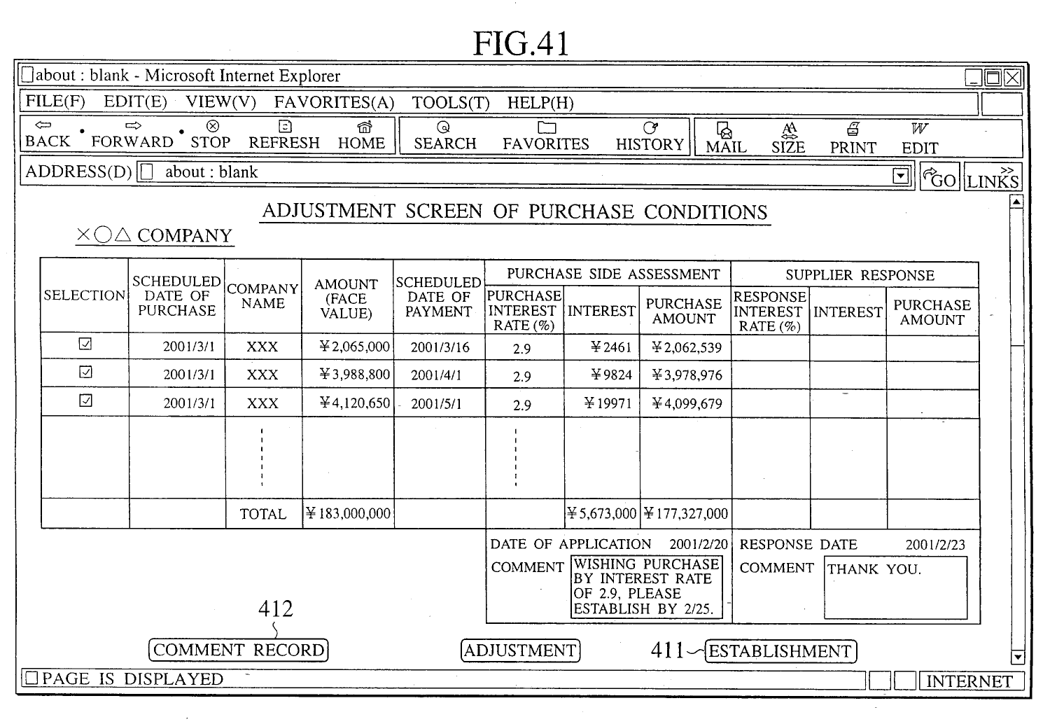

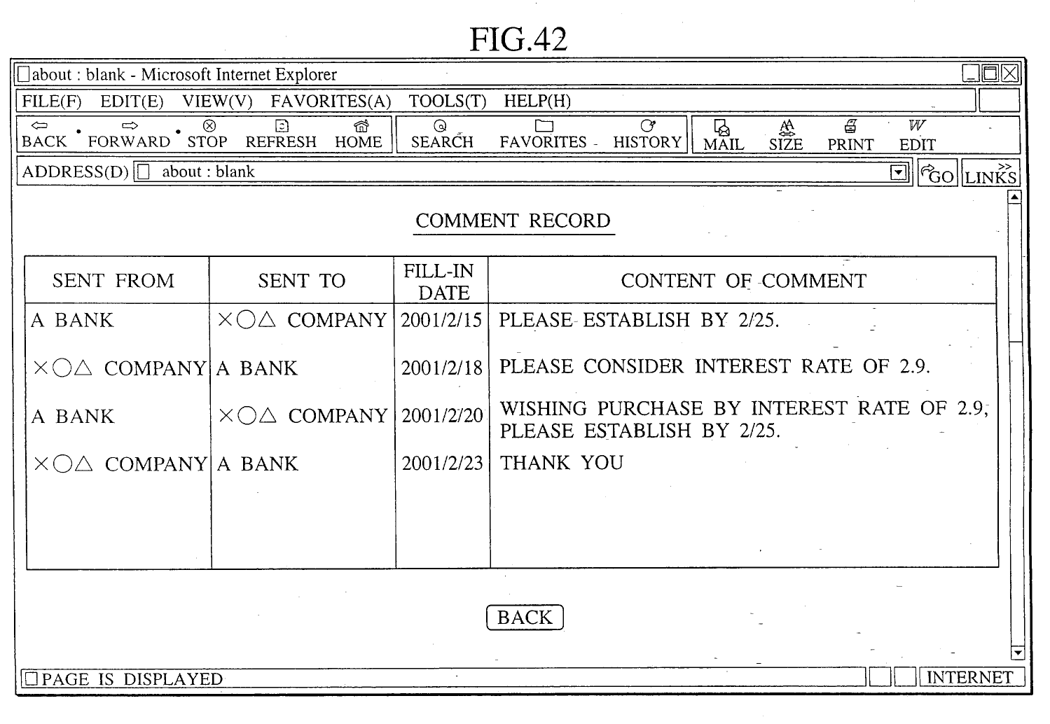

Other than the entry of the purchase interest rate or the like on the screen, negotiation may be made between the supplier and the purchase financial institution by using telephone or a chat function. In this case, by clicking “COMMENT RECORD” buttons 382, 392, 402 and 412 of FIGS. 38 to 41 in steps S1924 and S1925, comments on transactions can be entered on a screen similar to that of FIG. 42, and the entered comments are saved as purchase records.

As described above, since the purchase condition can be adjusted between the supplier and the purchase financial institution 6, sales credits can be sold and bought on the best condition for both.

Moreover, since the supplier and the purchase financial institution 6 can enter comments, negotiation for purchase conditions can be smoothly conducted therebetween.

After the purchase conditions have been established and transmitted to the factoring commission apparatus 1705, the factoring commission apparatus 1705 stores the purchase condition and the data of the credits available for factoring in the factoring information database 57, and notifies such condition and data to the purchase financial institution 6 (S1928).

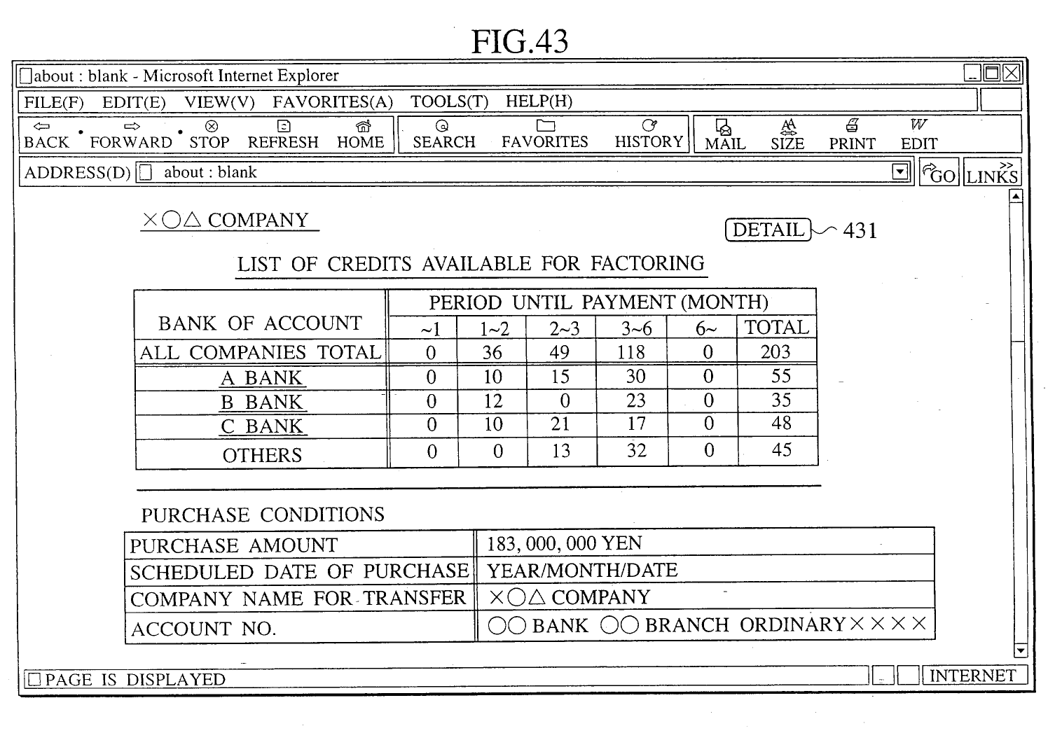

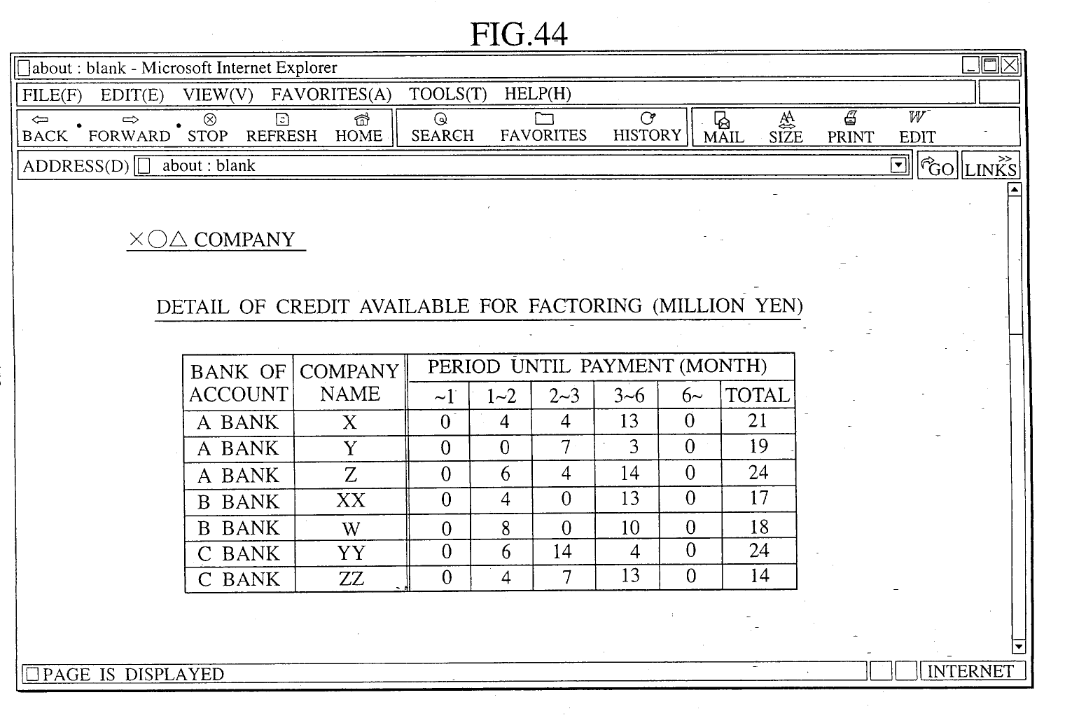

Then, the purchase financial institution 6 refers to the data available for factoring on a list screen of credits available for factoring shown in FIG. 43 (S1929). On this list screen, the credits available for factoring are shown by being classified by a bank of account and a period until payment, and it is also shown that the purchase financial institution 6 has agreed to buy credits by 183 million yen as a total amount of the credits. On the list screen of FIG. 43, by clicking a “DETAIL” button 431, a detail of credits available for factoring shown in FIG. 44 can be referred to for each company.

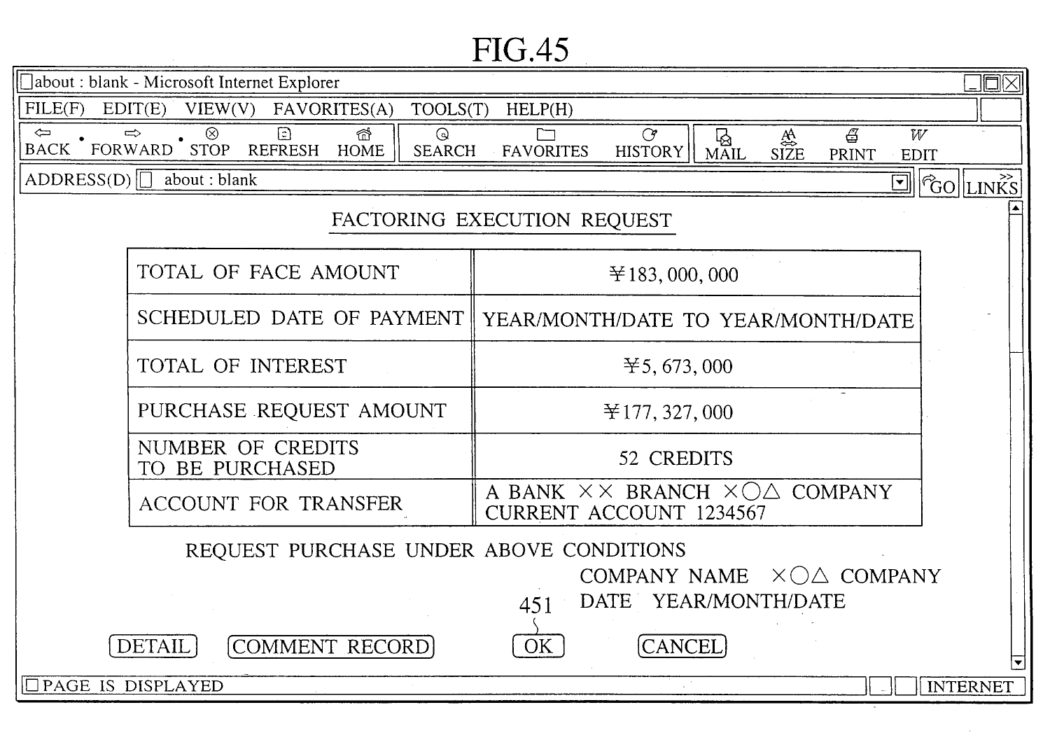

Then, by referring to FIGS. 43 and 44, when the purchase financial institution 6 makes a factoring execution request, an “OK” button 451 is clicked to enter a factoring execution request on a request screen of FIG. 45 and transmit the factoring execution request to the factoring commission apparatus 1705 (S1930).

Then, the factoring commission apparatus 1705 downloads data regarding sales credits to the purchase financial institution 6 based on the received execution request (S1931).

In this case, the factoring commission apparatus 1705 has a function of providing the data regarding the sales credits on an XML file format.

Thus, since the purchase financial institution 6 can obtain a data item given a meaning by a tag by using the above function, the purchase financial institution 6 can directly connect to a basic system based on such information and batch-process the data regarding sales credits as factoring information quickly.

In addition, based on the above information, the purchase financial institution 6 can obtain sales information by a buyer or a supplier as a user. Thus, customer information can be obtained as a financial institution, and also be used for other businesses (credit exposure management or the like).

At the purchase financial institution 6 that have received the data regarding the sales credits, a receiving account of purchased credits is protected (S1932), a purchase amount of money is received by the supplier specified financial institution 10 specified by the supplier (S1933), and a factoring execution notice is returned to the factoring commission apparatus 1705 (S1934).

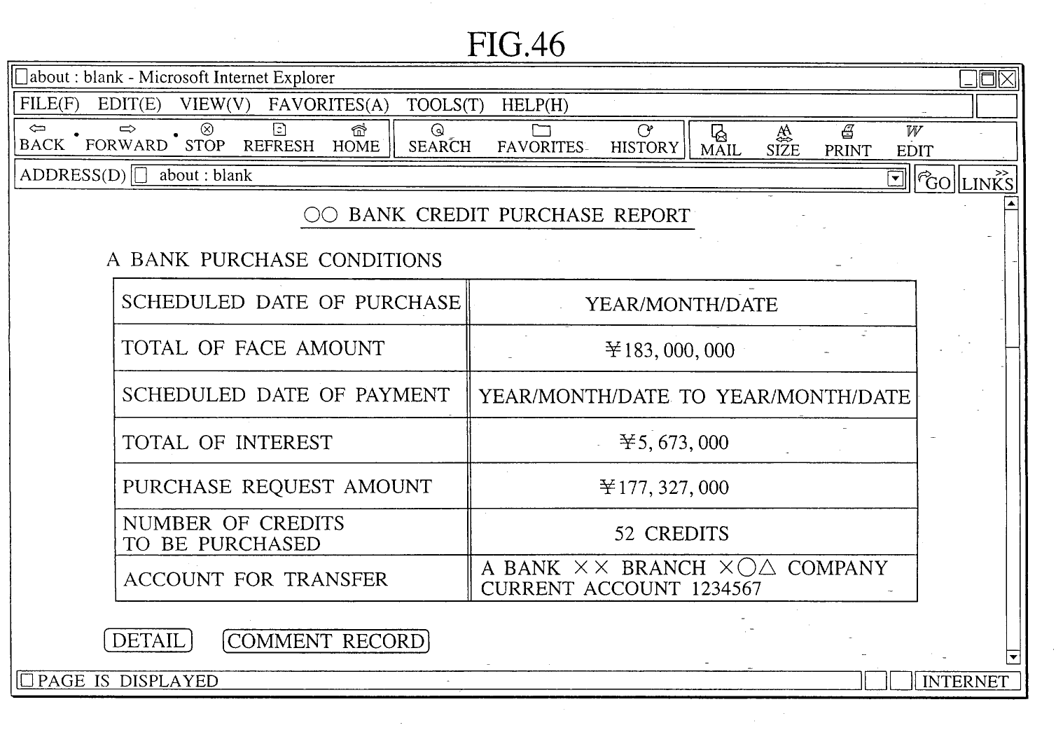

The factoring execution notice is transmitted from the factoring commission apparatus 1705 to the supplier (S1935). The supplier refers to a credit purchase report made by the purchase financial institution 6 on a report screen shown in FIG. 46 (S1936).

Further, after the purchase amount of money has been received by the account of the supplier, the supplier specified financial institution 10 transmits a notice of receipt of money to the supplier (S1937).

Subsequently, the buyer specified financial institution 11 pays for the credits to the purchase financial institution 6 not later than a due date of payment (S1938). In this case, if the factored credits are not paid for not later than the due date of payment, then the supplier buys back the credits that have been sold.

First, if any of the factored credits are not paid for on a due date of payment because of bankruptcy of the buyer or the like, the purchase financial institution 6 transmits a notice of non-receipt of money to the factoring commission apparatus 1705 (S1939).

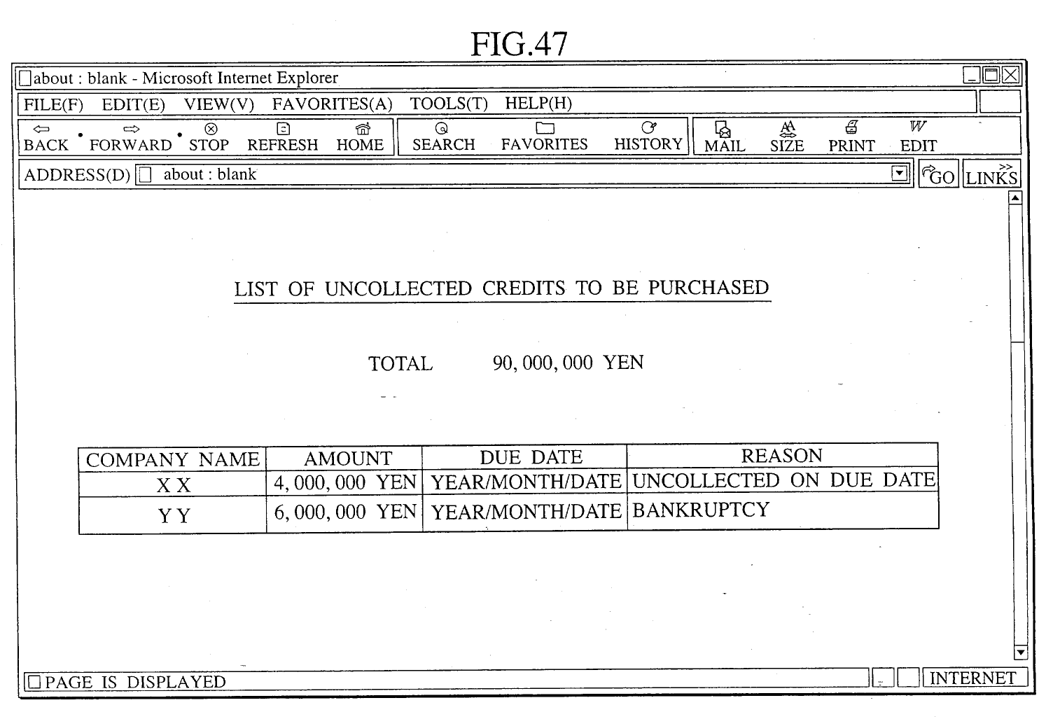

Then, upon having received the notice of non-receipt of money, the factoring commission apparatus 1705 notifies a credit buying-back request to the supplier (S1940). Upon having received such notice, the supplier verifies uncollected credits on a list screen shown in FIG. 47 (S1941), and transmits an instruction of remitting funds for collecting the uncollected credits to the supplier specified financial institution 10 (S1942).

Then, based on the fund-remittance instruction, the supplier specified financial institution 10 remits an amount of money for the uncollected credits to the purchase financial institution 6 (S1943). Thus, the processing of the uncollected credits is completed, and the factoring on commission by the factoring commission apparatus 1705 is finished.

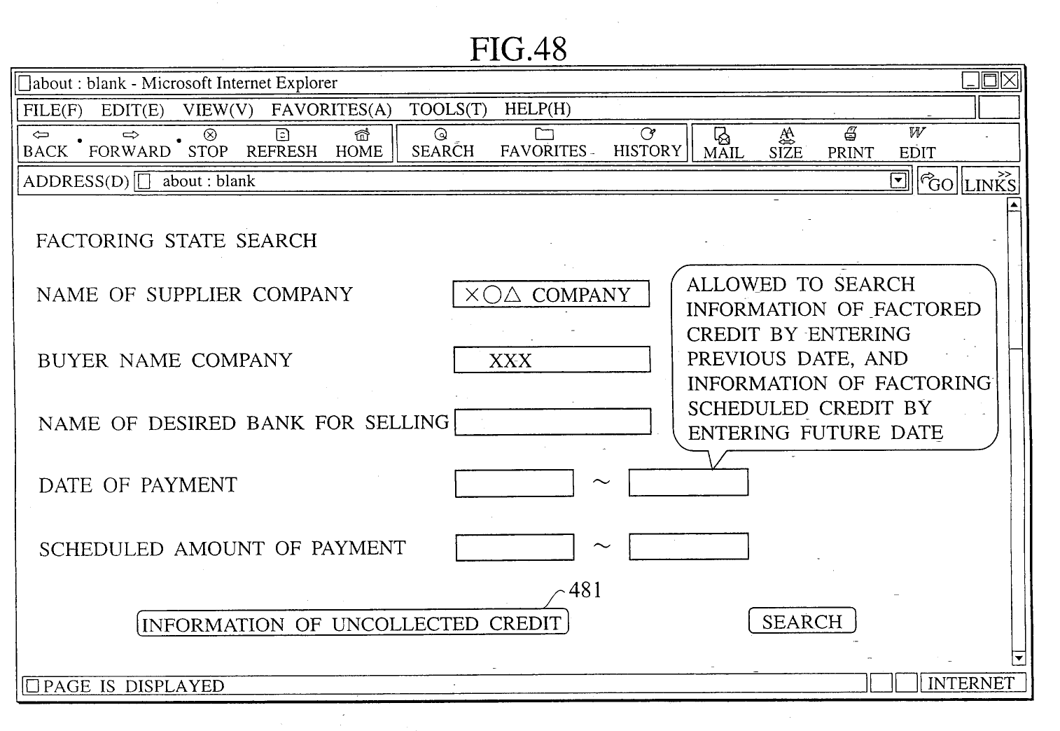

In the factoring commission system 1701 of the embodiment, a factoring commission company can search a factoring state through the management terminal 1716. In the search of the factoring state, the search is carried out by entering a search condition on a search screen similar to that shown in FIG. 48.

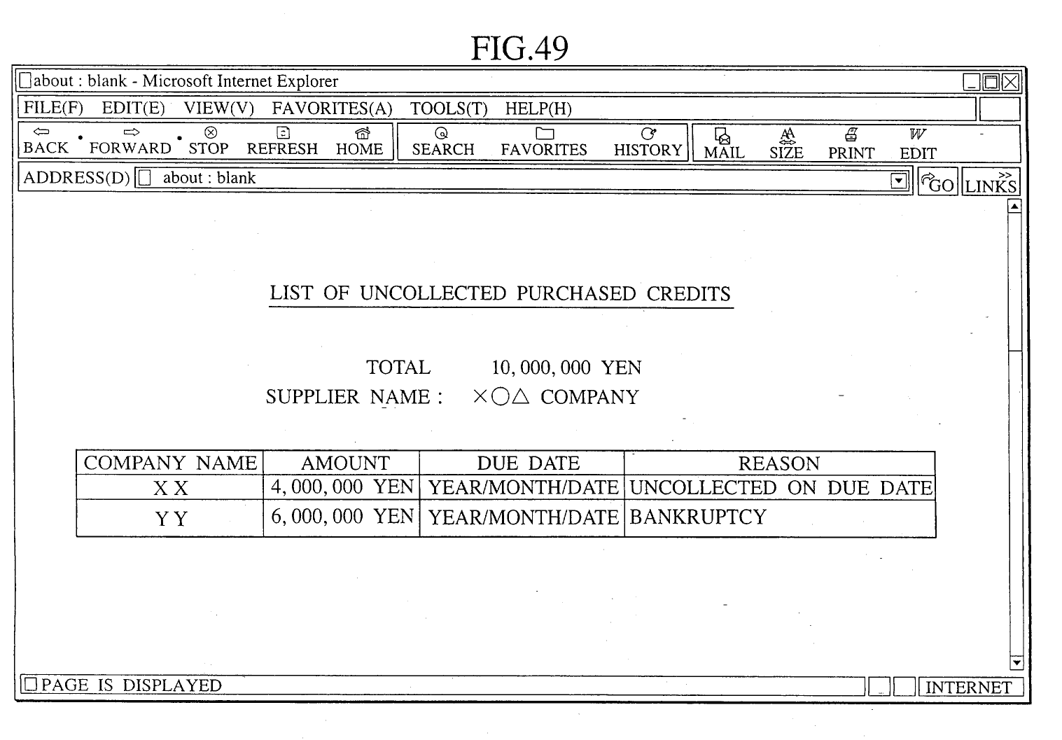

Further, when an “UNCOLLECTION INFORMATION” button 481 is clicked on the screen of FIG. 48, a list screen of uncollected purchased credits is displayed, similar to that shown in FIG. 49, and thus currently uncollected credits can be referred to.

Thus, the factoring commission company can always understand a factoring commission state and verify credits uncollected because of bankruptcy or the like.

As described above, in the factoring commission system 1701 of the embodiment, the factoring commission apparatus 1705 totals charge detail information and generates factoring target data for each supplier. Thus, it is possible to greatly reduce the burden of data processing for factoring imposed on the supplier.

In addition, the supplier can select a purchase financial institution from a number of financial institutions by specifying a factoring condition. Thus, it is possible to make factoring requests to many financial institutions.

Therefore, in accordance with the factoring commission system 1701 of the embodiment, the supplier can efficiently change sales credits into funds.

The example of transactions on the portal site has been described. Even in electronic business transactions on an e-marketplace, a Web-EDI or the like, the factoring commission system of the embodiment can perform factoring on commission.

Furthermore, the embodiment has been described by way of example of sales credit selling. However, the factoring commission system of the embodiment can process even credit granting from a financial institution on security of sales credits as in the case of sales credits selling.

Furthermore, programs for achieving the processing operations of the factoring commission apparatus 5 and 1705 of the foregoing factoring commission systems 1 and 1701 can be saved in a recording medium. By causing a computer system to read from the recording medium, the processing operations of the factoring commission apparatus 5 and 1705 can be achieved by executing the programs and controlling the computer. In this case, the recording medium includes a device capable of recording the programs, e.g., a memory, a magnet disk device, an optical disk device or the like.

As obvious from appended claims, such inventions are also within the technical scope of the present invention.

### INDUSTRIAL APPLICABILITY

As described above, according to the factoring commission system of the present invention, it is possible to reduce a burden of data processing for factoring imposed on a supplier, and batch-process factoring requests made by many suppliers to a number of financial institutions.

What is claimed is:

1. A factoring commission method, in which transactions are carried out between a supplier for supplying goods and a buyer for buying the goods through a portal site by a computer system and sales credits generated by the transactions are sold on commission by using a server, the factoring commission method comprising:
said server generating factoring target data to be subjected to factoring from charge detail information as information regarding a bill of charges generated as a result of the transactions on said portal site based on a factoring condition specified by said supplier;
said server transmitting the factoring target data to a purchase financial institution for buying sales credits and causing the purchase financial institution to extract a purchasable sales credit from the factoring target data and remit a payment for the purchasable sales credit to a supplier specified financial institution specified by said supplier.

2 A factoring commission apparatus, selling on commission sales credits generated by transactions, which are carried out by a supplier for supplying goods and a buyer for buying the goods through a portal site by a computer system, the factoring commission apparatus comprising:
factoring target data generation means for receiving charge detail information from said portal site as information regarding a bill of charges generated as a result of the transactions on said portal site and for generating factoring target data to be subjected to factoring based on a factoring condition specified by said supplier from the charge detail information; and
factoring means for transmitting said factoring target data generated by said factoring target data generation means to a purchase financial institution for buying sales credits and for causing the purchase financial institution to extract a purchasable sales credit from said factoring target data and remit a payment for the purchasable sales credit to a supplier specified financial institution specified by said supplier.

3 The factoring commission apparatus of claim 2, wherein said factoring target data generation means searches said charge detail information based on a search condition entered by said supplier and provides said charge detail information coincident with said search condition to said supplier.

4 The factoring commission apparatus of claims 2 or 3, further comprising distribution certifying means for presenting to said purchase financial institution a distribution certificate certifying that transacted goods have been delivered by a distribution company.

5 The factoring commission apparatus of claims 2, 3 or 4, wherein said factoring means makes said purchase condition of the purchasable sales credit, which is extracted by said purchase financial institution, to be adjusted and decided between said supplier and said purchase financial institution.

6 The factoring commission apparatus of claims 2, 3, 4 or 5, further comprising credit investigation information providing means for providing credit investigation information regarding credit of a company.

7. The factoring commission apparatus of claims 2, 3, 4, 5 or 6, further comprising factoring state providing means for providing information regarding a sales credit coincident with a factoring state search condition when the factoring state search condition for searching a factoring state is entered.

8 A factoring commission program, selling on commission sales credits generated by transactions, which is carried out by a supplier for supplying goods and a buyer for buying the goods through a portal site by a computer system, the factoring commission program comprising:
factoring target data generation process for receiving charge detail information from said portal site as information regarding a bill of charges generated as a result of the transactions on said portal site and for generating factoring target data to be subjected to factoring based on a factoring condition specified by said supplier from the charge detail information; and
factoring process for transmitting said factoring target data generated in said factoring target data generation process to a purchase financial institution for buying sales credits and for causing said purchase financial institution to extract a purchasable sales credit from said factoring target data and remit a payment for the purchasable sales credit to a supplier specified financial institution specified by said supplier.

9 The factoring commission program of claim 8, wherein said factoring target data generation process searches said charge detail information based on a search condition entered by said supplier and provides the charge detail information coincident with said search condition to said supplier.

10 The factoring commission program of claims 8 or 9, further comprising distribution certifying process for presenting to said purchase financial institution a distribution certificate certifying that transacted goods have been delivered by a distribution company.

11 The factoring commission program of claims 8, 9 or 10, wherein said factoring process adjusts and decides a purchase condition of the purchasable sales credit, which is extracted by said purchase financial institution, between said supplier and said purchase financial institution.

12 The factoring commission program of claims 8, 9, 10 or 11, further comprising credit investigation information providing process for providing credit investigation information regarding credit of a company.

13 The factoring commission program of claims 8, 9, 10, 11 or 12, further comprising factoring state providing process for providing information regarding a sales credit coincident with a factoring state search condition when the factoring state search condition for searching a factoring sate is entered.

14 A supplier terminal, provided to a supplier for supplying goods information to a portal site by a computer system and selling goods by transactions with a buyer, characterized by:
prompting said supplier to specify a factoring condition for generating factoring target data to be subjected to factoring from charge detail information of charges generated as a result of the transactions with said buyer;
transmitting the factoring condition to a server when the factoring condition is specified by said supplier; and
receiving a notice of receipt of money for verifying receipt of money after said factoring target data is generated by said server, a purchase financial institution for buying sales credits extracts a purchasable sales credit from said factoring target data, and the payment for said purchasable sales credit is received by a supplier specified financial institution specified by said supplier.

15 The supplier terminal of claim 14, wherein characterized in that when a search condition for searching possessed sales credits is entered by said supplier, said search condition is transmitted to said server, and charge detail information searched based on said search condition is received from said server and provided to said supplier.

16 The supplier terminal of claims 14 or 15, wherein characterized by prompting said supplier to enter a response to said purchase condition when a purchase condition of said purchasable sales credit, which is entered by said purchase financial institution, is received from said server, and transmitting said response to said server when said response is entered.
